(19) United States
(12) Patent Application Publication
(10) Pub. No.: US 2012/0158566 A1
(43) Pub. Date: Jun. 21, 2012

(54) TRANSACTION RATE PROCESSING APPARATUSES, METHODS AND SYSTEMS

(76) Inventors: Corinne Fok, (US); Brian Byrne, (US); Tom Manessis, Pacifica, CA (US)

(21) Appl. No.: 13/333,812

(22) Filed: Dec. 21, 2011

Related U.S. Application Data
(60) Provisional application No. 61/425,481, filed on Dec. 21, 2010.

(51) Int. Cl. G06Q 40/00

(52) U.S. Cl. 705/35

(57) ABSTRACT

The TRANSACTION RATE PROCESSING APPARATUSES, METHODS AND SYSTEMS (“TRP”) transforms merchant transaction-related information, merchant performance metrics, merchant security/management information, merchant risk-based information, and merchant industry-based information inputs via one or more of security-equipment-based adjustment component(s) (SEAC), security-process-based adjustment component(s) (SPAC), risk-tierage adjustment component(s) (RTAC), growth-rate incentive adjustment component(s) (GRIAC), transaction-volume incentive adjustment component(s) (TVIAC), high-risk assessment adjustment component(s) (HRAC), and merchant-industry adjustment component(s) (MIAC) into generated merchant transaction rate and merchant transaction rate incentive outputs that are distributed to individual merchants.

### RELATED APPLICATIONS

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

Applicant hereby claims priority under 35 USC §119 from U.S. provisional patent application Ser. No. 61/425,481, filed Dec. 21, 2010, entitled “Payment Processing System Performance-Based Interchange Rates,” attorney docket no. P-41386PRV|20270-092PV. The entire contents of the aforementioned application is herein expressly incorporated by reference.

### FIELD

The present invention is directed generally to apparatuses, methods, and systems for analyzing data, and more particularly, to TRANSACTION RATE PROCESSING APPARATUSES, METHODS AND SYSTEMS.

### BACKGROUND

Consumers engage in different transactions that are associated with, for example, different products or services offered by merchants. These different transactions produce data that may be stored for analysis and/or processing.

### BRIEF DESCRIPTION OF THE DRAWINGS

The accompanying appendices and/or drawings illustrate various non-limiting, example, inventive aspects in accordance with the present disclosure:

FIG. 1 is of a block diagram illustrating example aspects of providing transaction rates in some embodiments of the TRP;

FIGS. 2A-2B are of block diagrams illustrating example aspects of a transaction rate determination process in some embodiments of the TRP;

FIGS. 3A-3B are of logic flow diagrams illustrating a transaction rate 13 determination process in some embodiments of the TRP;

FIGS. 4A-4B are of block diagrams illustrating example aspects of a transaction rate determination model associated with security in some embodiments of the TRP;

FIGS. 5A-5B are of block diagrams illustrating example aspects of a transaction rate determination model associated with merchant performance-metrics in some embodiments of the TRP;

FIGS. 6A-6B are of block diagrams illustrating example aspects of a transaction rate determination model associated with merchant growth-rate in some embodiments of the TRP;

FIGS. 7A-7B are of block diagrams illustrating example aspects of a transaction rate determination model associated with merchant transaction-volume in some embodiments of the TRP;

FIG. 8 is of a logic flow diagram illustrating example aspects of a transaction rate determination model associated with merchant risk in some embodiments of the TRP;

FIG. 9 is of a logic flow diagram illustrating example aspects of a transaction rate determination model associated with a merchant's industry in some embodiments of the TRP;

FIG. 10 is of a block diagram illustrating embodiments of the TRP controller;

FIG. 11 is block diagram illustrating embodiments of a financial payment processing system for determining interchange rates to incentivize merchants;

FIG. 12 is of a logic flow diagram illustrating an exemplary method for calculating performance-based interchange rates;

FIGS. 13-14 are of logic flow diagrams illustrating additional details of the exemplary method of FIG. 12

FIG. 15 is of a logic flow diagram illustrating an exemplary method of determining the average interchange rate and the overall financial impact from industry based initiatives and from predicted reactions to performance-based interchange rate incentives;

FIG. 16 shows a screen shot of an exemplary user interface that enables a transaction handler or payment processor to define several interchange discount or penalty tiers;

FIG. 17 shows a screen shot of an exemplary user interface displaying results calculated from the tiers defined in FIG. 16 of the distribution by settlement amount and the actual currency amount for each tier;

FIG. 18 shows a screen shot of exemplary results calculated from the tiers defined in FIG. 16 of the distribution of merchants and volume by volume tier;

FIG. 19 shows a screen shot of an exemplary user interface that enables the transaction handler or payment processor to set the overall interchange rate discounts and penalties;

FIG. 20 shows a screen shot of an exemplary user interface that enables the transaction handler or payment processor to define interchange rate discounts or penalties related to strategic initiatives;

FIG. 21 shows a screen shot of an exemplary performance-based 18 interchange rate results by industry calculated by the methods of FIGS. 12-15; and

FIGS. 22(a)-(d) show screen shots of exemplary results of the performance-based interchange model calculated by the method of FIG. 15.

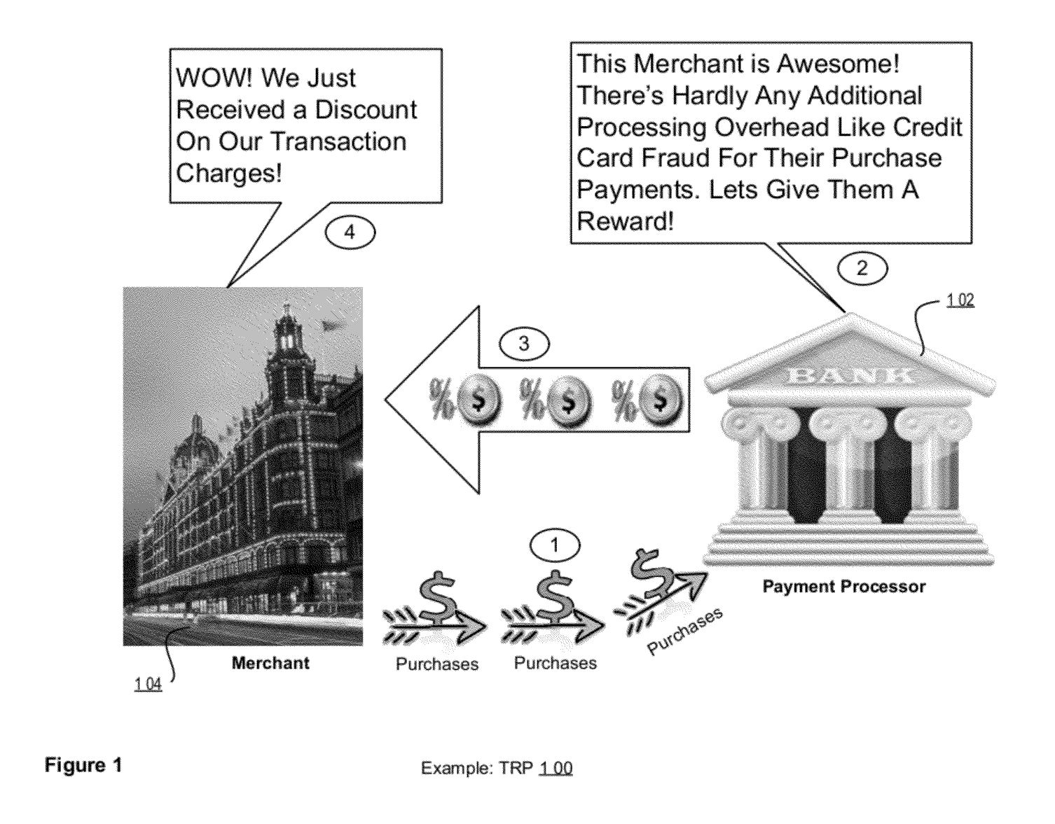

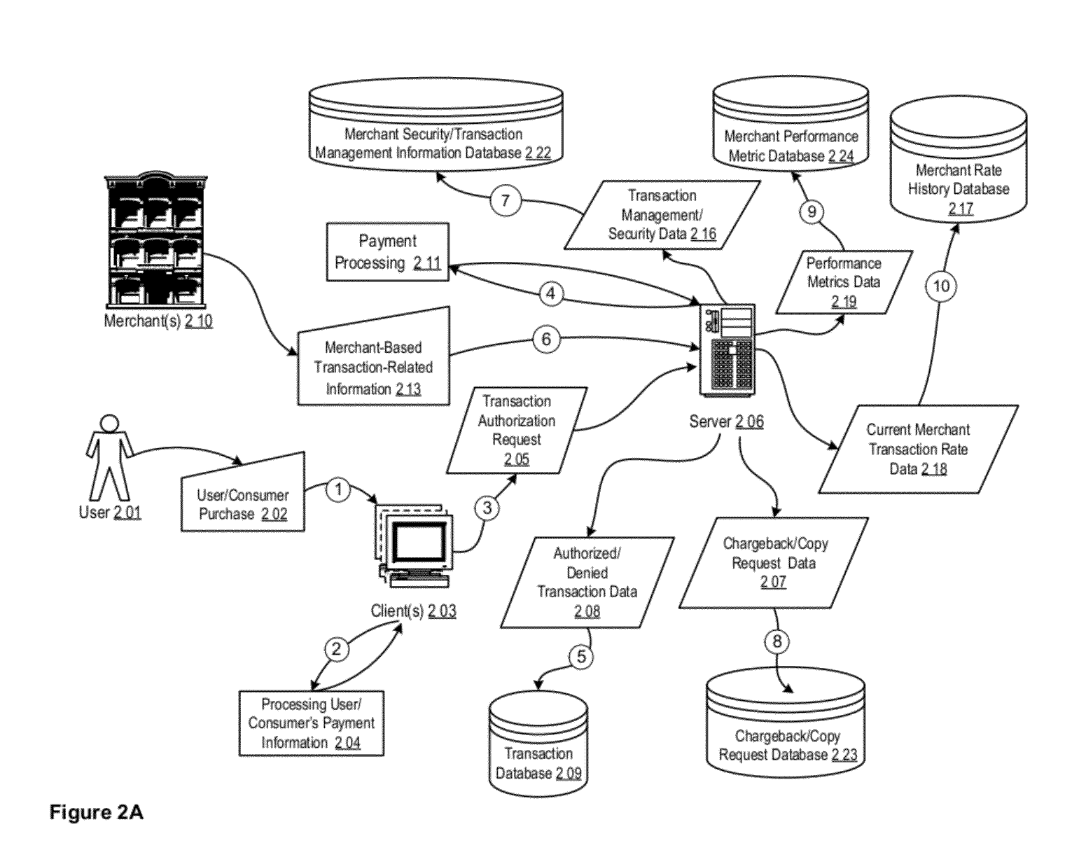

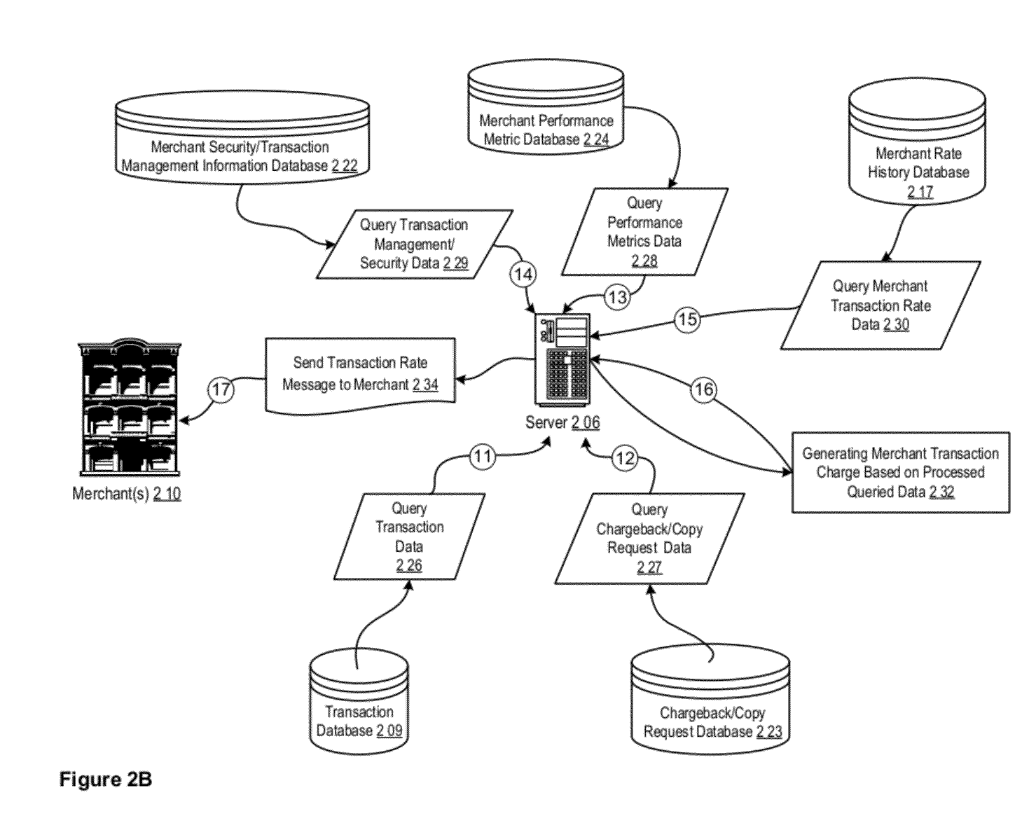

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### TRP

The use of various payment instruments such as credit cards require processing and handling by payment processors (e.g., VISA) on behalf of issuer banks, merchant (i.e., acquirer) banks, and merchants. The cost of such handling and processing (e.g., an interchange rate) is normally passed onto the merchants as, for example, a transaction rate given by a percentage (e.g., %1.2) of the purchased items. As described in the following, certain metrics (e.g., credit card fraud) increase or decrease the cost overhead of handling and processing (e.g., an interchange rate) payments made to a merchant. Therefore, on this basis, the increase or decrease in cost overhead may be reflected as providing the merchant with an adjusted transaction rate (e.g., an adjusted interchange rate), whereby an increased processing overhead (e.g., due to increased fraud activity) produces an adjusted increase in the merchant's transaction rate (e.g., %1.35), while conversely a decrease in cost overhead (e.g., due to reduced fraud activity) produces an adjusted decrease or bonus associated with the transaction rate (e.g., %1.15).

FIG. 1 is of a block diagram illustrating example aspects of providing transaction rates in some embodiments of the TRP. A payment processing entity 102 receives and processes user or customer payment transactions on behalf of various merchants 104. Since the payment processing entity 102 processes user or consumer payment transactions associated with the merchants 104, it is capable of determining any overhead associated with these payment transactions. For example, such overhead may include, without limitation, processing fraudulent transactions, processing charge backs, processing copy requests, etc. Thus, the payment processing entity 102 may attribute and process various performance metrics that are associated with the overhead generated by the various merchants 104. For example, such performance metrics may include, without limitation, a merchant's fraud rate, a merchant's sales volume, a merchant's sales growth rate, a merchant's charge back rate, a merchant's copy request rate, a merchant's security protocols for fraud detection, a merchant's industry and product sales category, a merchant's use of secure transaction equipment, etc. Based on the various merchant performance metrics, the payment processing entity 102 may adjust a merchant's transaction rate (e.g., an interchange rate) to either the merchant's detriment (i.e., an increased rate or penalty) or benefit (i.e., a reduced transaction rate or discount), thus, among other things, encouraging secure and efficient transaction or transaction-related activities by merchant.

FIGS. 2A-2B are of block diagrams illustrating example aspects of a transaction rate determination process in some embodiments of the TRP. Referring to FIG. 2A, a user or consumer 201 may desire to make a sales purchase by providing payment information (e.g., bank account or credit card data) 202, via a payment device, to a client device 203 such as a merchant's point-of-sale (POS) terminal. In some example aspect, the client device 203 may be a user or consumer's 201 web-enable computer (e.g., laptop, desktop, tablet, etc.) or a mobile communication device (e.g., PDA, smartphone, etc.). The client device 203 processes the user or consumer's payment information 204 and transmits this payment information in the form of a transaction authorization request 205 to a computer server 206. The server 206 may then facilitate a payment transaction process 211 with several other financial entities (not shown) such as, for example, an issuer (e.g., user's bank), an acquirer (e.g., merchant's bank), and a payment processor institution (e.g., VISA). Upon processing of the user or consumer's transaction request, the server receives a “transaction authorized” or a “transaction denied” message from one of the financial entities (e.g., VISA).

The above-described TRP process may generate a request for user or consumer transaction data, e.g., 205, whereby, for example, the server, e.g., 206, may receive a HTTP(S) POST request similar to the example below:

POST /transactionrequest.php HTTP/1.1
Host: www.TRPprocess.com
Content-Type: Application/XML
Content-Length: 788
<?XML version = “1.0” encoding = “UTF-8”?>
<transactionData_request>
<timestamp>2011-02-22 17:00:01</timestamp>

<user_account_params>

<user_account_ID>1234567JS</ user_account_ID>
<account_name>John Smith</account_name>
<account_type>credit</account_type>
<account_num>123455789012345</account_num>

</user_account_params>
<merchant_params>

<merchant_id>3FBCR4INC</merchant_id>
<merchant_name>Apple Store</merchant_name>
<merchant_Industry>electronic goods</merchant_industry>
<merchant_Location>Manhattan 10022</merchant_Location>
<purchase_price>$599</purchase_price>

</merchant_params>
<purchase_summary>

<num_products>1</num_products>
<purchased_item>iPad tablet computer</purchased_item>

</purchase_summary>

</transactionData_request>

The server sends transaction data 208 (e.g., user or consumer's financial account information) associated with the “authorized” or “denied” transaction to a transaction database 209. The transaction data may include information corresponding to the sales purchase (e.g., goods or services purchased) such as a description code (e.g., NAICS: North American Industry Classification System) associated with the purchased item, cost of the purchased item, the date of transaction, and information associated with the merchant. The transaction data may also include information regarding one or more of the user or consumer's mobile communication devices (not shown) that may be used to communicate with the client device 203. Such mobile communication device information may include, but is not limited to, the device name (e.g., Apple iPhone™, Motorola Droid™, etc.), a user-determinable device preference (e.g., Apple iPhone™ device) for establishing communications, and any secure financial data transfer application software/hardware used on the device for interacting with the client device 203. In some implementations, the transaction data may also include information regarding the denial of the transaction along with the time of the transaction denial.

The above-described TRP process may generate a user or consumer transaction data message, e.g., 208, whereby, for example, the server, e.g., 206, may send a HTTP(S) POST message similar to the example below:

POST /transactiondata.php HTTP/1.1
Host: www.TRPprocess.com
Content-Type: Application/XML
Content-Length: 788
<?XML version = “1.0” encoding = “UTF-8”?>
<transactionData_info>
<timestamp>2011-02-22 17:00:01</timestamp>

<user_account_params>

<user_account_ID>1234567JS</ user_account_ID>
<account_name>John Smith</account_name>
<account_type>credit</account_type>
<account_num>123455789012345</account_num>

</user_account_params>
<merchant_params>

<merchant_id>3FBCR4INC</merchant_id>
<merchant_name>Apple Store</merchant_name>
<merchant_Industry>electronic goods</merchant_industry>
<merchant_Location>Manhattan 10022</merchant_Location>
<purchase_price>$599</purchase_price>

</merchant_params>
<purchase_summary>

<num_products>1</num_products>
<purchased_item>iPad tablet computer</purchased_item>
<NAICS>code 1</NAICS>

</purchase_summary>
<purchase_activity>

<status>″DENIED″</status >
<reason>″FRAUD: stolen card used″</reason>

</purchase_activity>
<user_device>

<type>iPhone</type >
<app_type>secure</app_type>
<app_name>secure_transaction_3.0</app_name>

</user_device>

</transactionData_info>

The server computer 206 may also receive merchant-based transaction-related information 213 from each merchant 210. For example, the merchant-based transaction-related information 213 may include information regarding any fraud detection or transaction security procedures such as checking consumer IDs (e.g., drivers license), consumer signatures, generating/processing consumer specific challenge/response questions at the POS or during an online purchase, and/or logging one or more device attributes, such as IP address and device ID, of a user or consumer's device (e.g., smartphone, computer, etc.) used in prior authorized merchant transactions.

According to other examples, the merchant-based transaction-related information 213 may include information regarding various security features implemented by the transaction devices (e.g., POS) employed by the merchant. These security features may be product based, such as, the use of a particular make or model of device that guarantees a certain level of security during the transaction process between the purchasing user or consumer and the merchant. Some security features may, for example, be based on the use of one or more secure data transfer applications running on both a user's communication device (e.g., iPhone running secure purchase application) and a merchant's POS (e.g., also running the secure purchase application). Once received, the server computer 206 then stores the transaction management/security data 219 to a merchant security/transaction management information database 222.

The above-described TRP process may generate a merchant-based transaction-related information (e.g., security) message, e.g., 213, 216, whereby, for example, the server, e.g., 206, may receive or generate a HTTP(S) POST message similar to the example below:

POST /merchanttransactionSECURITYinformation.php HTTP/1.1
Host: www.TRPprocess.com
Content-Type: Application/XML
Content-Length: 788
<?XML version = “1.0” encoding = “UTF-8”?>
<transaction_management_AND_security_process>
<timestamp>2011-02-22 17:00:01</timestamp>

<merchant_params>

<merchant_id>3FBCR4INC</merchant_id>
<merchant_name>Apple Store</merchant_name>
<merchant_Industry>electronic goods</merchant_industry>

</merchant_params>
<security_check_procedures>

<check_1>request_ID_DL</check_1>
<check_2>signature_checking</check_2>
<check_3>challenge_response_POS_generation</check_3>
<check_4>logged_prior_secure_user_devices</check_4>

</security_check_procedures>
<transaction_equipment>

<type>POS</type>
<product>TXSecure</product>
<encryption>financial_secure_DES4</encryption>
<software>secure_transmission_app</software>
<software_version>2.0</software_version>
<last_sw_update>12/10/2010</last_sw_update>

</transaction_equipment>

</ transaction_management_AND_security_process>

Also charge back (i.e., return of funds to user/consumer) and copy requests (e.g., cardholders questioning or disputing transactions appearing on their billing statements) associated with a user or customer merchant transaction may be received, processed, and stored by the server computer 206 to a chargeback/copy request database 223.

The above-described TRP process may generate a charge back/copy request message, e.g., 207, whereby, for example, the server, e.g., 206, may send a HTTP(S) POST message similar to the example below:

POST /chargebackANDcopyrequestinformation.php HTTP/1.1
Host: www.TRPprocess.com
Content-Type: Application/XML
Content-Length: 788
<?XML version = “1.0” encoding = “UTF-8”?>
<overhead_information>
<timestamp>2011-02-22 17:00:01</timestamp>

<charge_back>

<merchant_ID>xxxxxxx</merchant_ID>
<transaction_no>0000000abc</transaction_no>
<chargeback_amount>$550.00</chargeback_amount>
<chargeback_date>10/10/2010</chargeback_date>
<payment_intrument_type>MASTERCARD</payment_intrument_type>

</charge_back>
<copy_request>

<merchant_ID>yyyyyyy</merchant_ID>
<transaction_no>0000000xyz</transaction_no >
<copy_request_date>10/10/2010</copy_request_date>
<payment_intrument_type>VISA</payment_intrument_type>

</copy_request>

</overhead_information>

The server computer 206 also generates 219 and stores performance metric tables that are associated with the merchant's 210 transactions in a merchant performance metric database 224. The performance metrics may include, for example, a merchant's fraud rate, a merchant's sales volume, a merchant's sales growth rate, a merchant's charge back rate, a merchant's copy request rate, a merchant's security protocols/equipment for fraud detection and security enhancement, a merchant's industry and product sales category, a merchant's use of secure transaction equipment, a merchants transaction velocity (i.e., targeted sales over a period), etc. According to some implementations, the stored performance metric tables within the merchant performance metric database 224 provide, for each merchant, a performance metric and corresponding transaction rate adjustment values. For example, for a fraud rate of 0.055% taken over a sales volume of 33%, a corresponding transaction rate adjustment value of 0.0% may be assigned. For a fraud rate of 0.013% taken over a sales volume of 33%, a corresponding transaction charge adjustment value of −0.07% (a discount) may be assigned, whereby the merchant's transaction charge value will be reduced by the adjustment value of −0.07% (a discount). For a fraud rate greater than 0.055% taken over a sales volume of 33%, a corresponding transaction rate adjustment value of 0.13% (a penalty) may be assigned, whereby the merchant's transaction rate value will be increased by the adjustment value of 0.13% (a penalty).

The above-described TRP process may generate a performance metric data message, e.g., 216, whereby, for example, the server, e.g., 206, may send a HTTP(S) POST message similar to the example below:

POST /performanceMETRICSinformation.php HTTP/1.1
Host: www.TRPprocess.com
Content-Type: Application/XML
Content-Length: 788
<?XML version = “1.0” encoding = “UTF-8”?>
<performance_metrics_information>
<timestamp>2011-02-22 17:00:01</timestamp>
<merchant_params>

<merchant_id>3FBCR4INC</merchant_id>
<merchant_name>Apple Store</merchant_name>
<merchant_Industry>electronic goods</merchant_industry>

```
  </merchant_params>
  <Fraud_Rate_Metric>
```

<Rate1>0%-1.0%</Rate1>
<transaction_adjust_val1>−0.001%</transaction_adjust_val1>
<Rate2>1.1%-2.0%</Rate2>
<transaction_adjust_val2>+0.002%</transaction_adjust_val2>
<Rate3>2.1%-5.0%</Rate3>
<transaction_adjust_val3>+0.003%</transaction_adjust_val3>

```
  </Fraud_Rate_Metric>
  <POS_type_Metric>
```

<POS_product1>TxSecure</POS_product1>
<transaction_adjust_val1>−0.0015%</transaction_adjust_val1>
POS_product2>GX500</POS_product2>
<transaction_adjust_val2>0.0%</transaction_adjust_val2>
POS_product3>TLO9000</POS_product3>
<transaction_adjust_val3>+0.0018%</transaction_adjust_val3>

```
  </POS_type_Metric>
  <Industry_type_Metric>
```

<Industry1>electronic_goods</Industry1>
<transaction_adjust_val1>+0.0007%</transaction_adjust_val1>
<Industry2>kids_clothing</Industry2>
<transaction_adjust_val2>−0.0001%</transaction_adjust_val2>
<Industry3>furniture</Industry3>
<transaction_adjust_val1>−0.0007%</transaction_adjust_val1>

</Industry_type_Metric>
</performance_metrics_information>

The server computer 206 also generates 218 and stores merchant transaction rate data in a merchant rate history database 217. The merchant transaction rate data may provide a historical determination of any fluctuations in the merchant's 210 stored transaction rate values over a period of time. The merchant transaction rate data also provides an up-to-date determination of the merchant's current transaction rate value, which may be utilized as a base transaction rate value for aggregating the various determined transaction rate adjustment values (see following paragraphs). As further explained in the following paragraphs, the fluctuations in the merchant's 210 stored transaction rate values may also be used by the server 206 to determine whether the merchant is eligible for receiving either or both transaction adjustment value discounts or incentive feedback information for potential future transaction adjustment value discounts.

The above-described TRP process may generate a merchant transaction rate data message, e.g., 218, whereby, for example, the server, e.g., 206, may send a HTTP(S) POST message similar to the example below:

POST /merchantTRANSACTIONRATEinformation.php HTTP/1.1
Host: www.TRPprocess.com
Content-Type: Application/XML
Content-Length: 788
<?XML version = “1.0” encoding = “UTF-8”?>
<merchant_transaction_rate_info>
<timestamp>2011-02-22 17:00:01</timestamp>

<merchant_ID>xxxxxxx</merchant_ID>
<date>10/10/2010</date>
<transaction_rate_val>0.00023%</transaction_rate_val>
<metrics_used>

<fraud_rate>0.002%</fraud_rate>
<charge_back_rate>0.045%</charge_back_rate>
<POS_type>TxSecure</POS_type>

</metrics_used>

</merchant_transaction_rate_info>

Referring to FIG. 2B, the server 206 queries the various databases in order to access data and generate a transaction rate (e.g., an interchange rate) for the merchant 210. For example, the server 206 queries 226 the transaction database 209 for transaction data associated with the merchant, queries 227 the chargeback/copy request database 223 for charge back and copy request data associated with the merchant, queries 228 the merchant performance metric database 224 for performance metric data associated with the merchant, queries 229 the merchant security/transaction management information database 222 for transaction management/security data associated with the merchant, and queries 230 the merchant transaction rate history database 217 for current and/or prior merchant transaction rate data (e.g., merchant interchange rate data) associated with the merchant. The above-described TRP database queries may be generated by sending HTTP(S) POST messages similar to the examples provided above.

At least some or all of the accessed data obtained via the database queries are processed 232 by the server 206 in order to generate a merchant transaction rate. The merchant transaction rate is then sent 234 to the merchant 210.

The above-described TRP process may generate a merchant transaction rate data message, e.g., 234, whereby, for example, the server, e.g., 206, may send a HTTP(S) POST message similar to the example below:

POST /merchantTRANSACTIONRATE.php HTTP/1.1
Host: www.TRPprocess.com
Content-Type: Application/XML
Content-Length: 788
<?XML version = “1.0” encoding = “UTF-8”?>
<merchant_transaction_rate>
<timestamp>2011-02-22 17:00:01</timestamp>

<merchant_ID>xxxxxxx</merchant_ID>
<date>10/10/2010</date>
<current_transaction_rate>0.0165%</current_transaction_rate>
<previous_transaction_rate>0.021%</previous_transaction_rate>
<rate_calculation>

<fraud_rate_adjust>−0.0020%</fraud_rate_adjust>
<charge_back_rate_adjust>−0.0045%</charge_back_rate_adjust>
<POS_type_adjust>+0.0030</POS_type_adjust>
<net_metric_adjust>−0.0035%</net_metric_adjust>
<base_rate>0.0200%</base_rate>
<current_rate_calc>0.0200%-0.0035%=0.0165%</current_rate_calc>

</rate_calculation>
<feedback>

<incentive1>″reduce fraud by another 23 instances between
June 2011 and September 2011, & receive a fraud adjustment
discount of −0.0055%″</incentive1>
<incentive2>″up grade POS to TxSecure & receive a security
adjustment discount of −0.0070%″<incentive2>

</feedback>

</merchant_transaction_rate>

As shown in the above HTTP(S) POST message, the merchant is provided with an updated current transaction rate and an indication of their previous transaction rate. In addition, the metrics used in the calculation may also be provided to the merchant 210 as a means of enabling the merchant to assess the factors (e.g., fraud rate, etc.) that bear the most impact on their determined transaction rate. Also, the message may include a target feedback incentive that encourages the merchant to improve one or more performance metrics that are used to adjust their transaction rate. For example, the message may provide an incentive to reduce instances of fraud over a period of time. According to another example, the merchant 210 may be invited to upgrade their current transaction processing equipment (e.g., POS terminals) to more secure devices having increased built-in fraud detection and avoidance features.

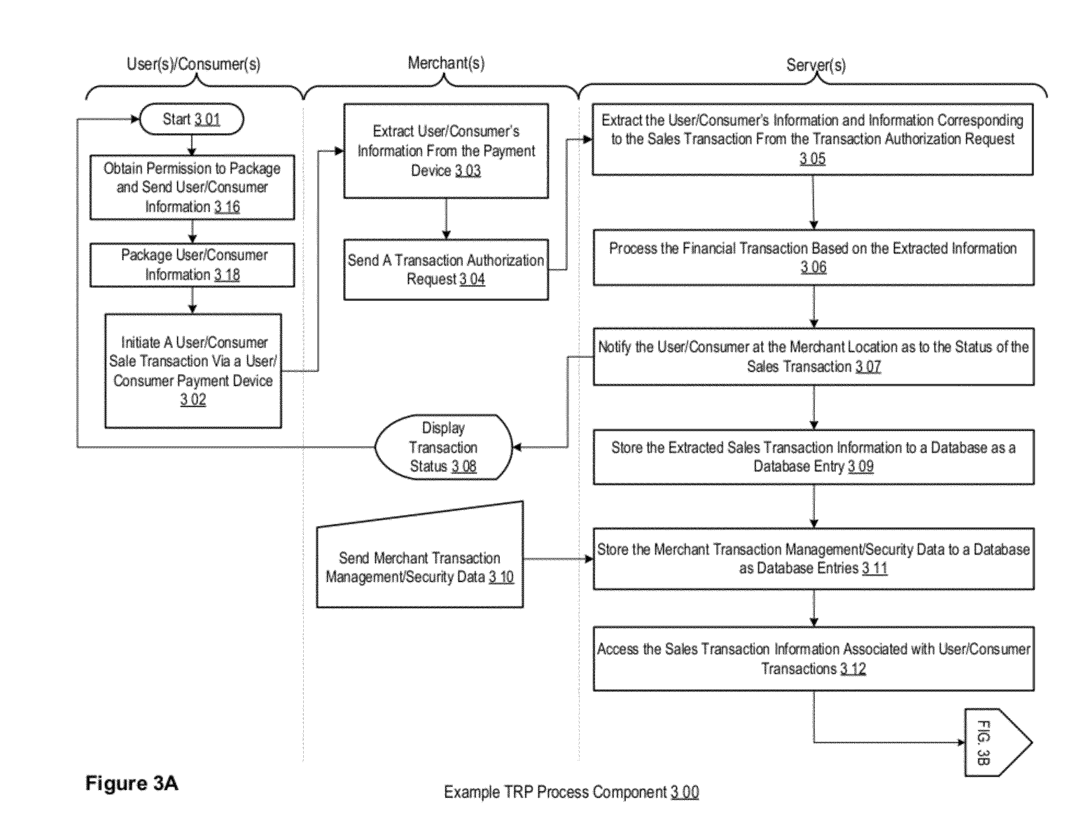

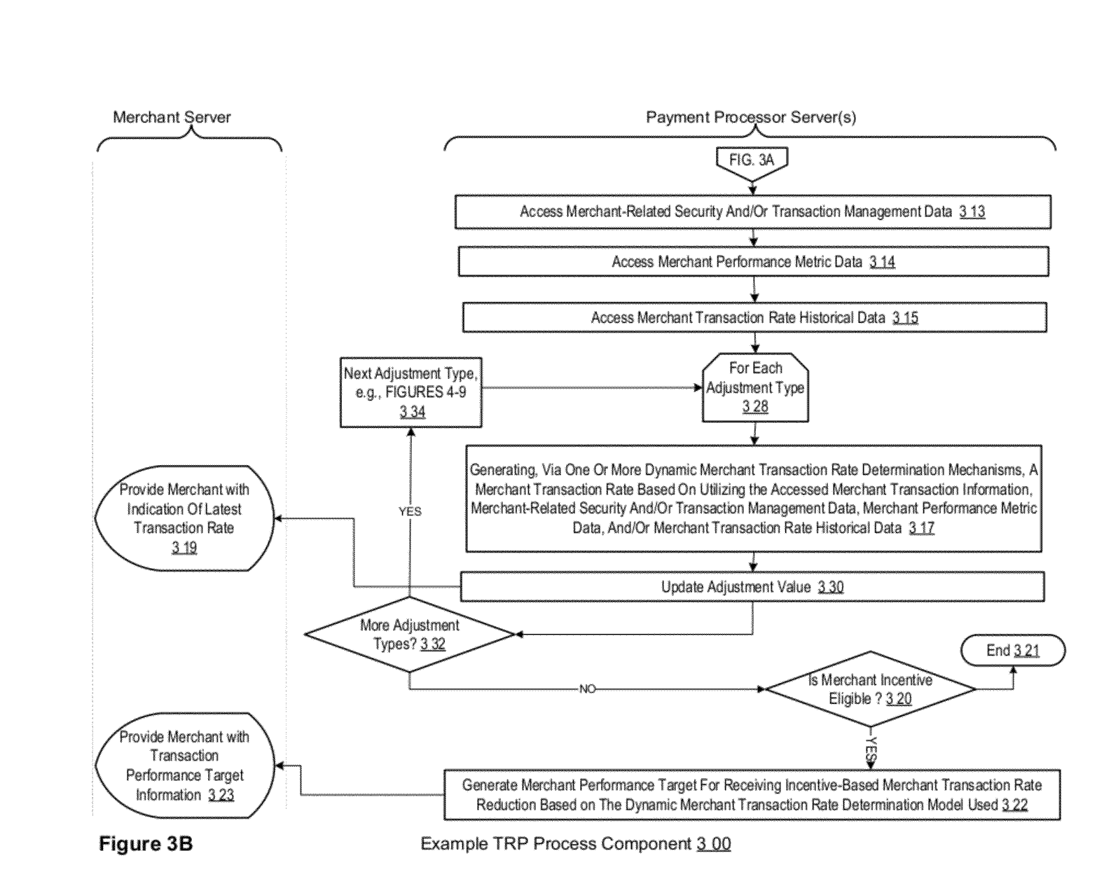

FIGS. 3A-3B are of logic flow diagrams 300 illustrating a transaction rate determination process in some embodiments of the TRP. A user or consumer may, for example, initiate a sale transaction via the user or consumer's payment device 302. The payment device may be any mechanism by which the user or consumer is able to pursue a sales transaction with a merchant. For example, a payment device may include a smart card (e.g., Visa payWave™ technology), a credit card having a magnetic strip, an electronic wallet, or any mobile communication device (e.g., smart phone, PDA, etc.) capable of facilitating a sales transaction at a merchant's POS terminal. Prior to initiating the transaction 302, the user or consumer may be required to confirm that permission is given to package and send the user or consumer's information to a merchant or other entity 316 (e.g., VISA). For example, in the event that the user or consumer uses a mobile communication device as an e-wallet, an application executing an e-wallet function may request the user or consumer's permission prior to packaging and sending the user or consumer's information to a merchant. Once the user or consumer grants permission, the user or consumer's information may be packaged for transmission to a merchant or other entity 318 upon initiation of the sales transaction 302.

At a merchant's business location, once the user or consumer's information is extracted from the payment device 303 by the POS device, a transaction authorization request is sent 304 from the merchant's POS device to at least one computer server associated with a payment processor (e.g., VISA). At the server, the user or consumer's information (e.g., user's identification, user's account information, user's mobile communication device information, etc.) and information corresponding to the sales transaction and merchant (e.g., merchant identity, merchant contact information, price of goods/services, description of goods/services, etc.) is extracted from the transaction authorization request 305.

In conjunction with computer servers of several other financial entities (e.g., user's issuer bank, merchant's acquirer bank, etc.), the information extracted from the transaction authorization request (e.g., user's account information and purchase information) is processed 306. Based on this processing, the user or consumer is notified as to the status of the initiated sales transaction 307, whereby a status notification (i.e., “Authorized” or “Denied”) message is sent to, and displayed at, the merchant's POS terminal or device 308.

The extracted information associated with the user or consumer (e.g., user's identification, user's account information, user's mobile communication device information, user's transaction status or authorization or denial, etc.), the sales transaction, and the merchant (e.g., merchant identity, price, description of goods/services, etc.) are stored as one or more entries in a database 309. Various merchants may also send transaction management and security data to the server 310, whereby the transaction management and security data is also stored as one or more database entries in a database 311. In some implementations, the transaction management and security data include information associated with any fraud detection or transaction security procedures such as checking consumer IDs (e.g., drivers license), consumer signatures, generating/processing consumer specific challenge/response questions at the POS or during an online purchase, and/or logging one or more device attributes, such as IP address and device ID, of a user or consumer's device (e.g., smartphone, computer, etc.) used in prior authorized merchant transactions. According to other examples, the merchant-based transaction-related information may include information regarding various security features (i.e., software/hardware/firmware, etc.) implemented by the merchant's transaction devices (e.g., POS). These security features may be product based, such as, the use of a particular make or model of device that guarantees a certain level of security during the transaction process between the purchasing user or consumer, and the merchant. Some security features may, for example, be based on the use of one or more secure data transfer applications running on both a user's communication device (e.g., iPhone running secure purchase application) and a merchant's POS (e.g., also running the secure purchase application).

The information (i.e., user, sale, and merchant related) associated with the user or consumer sales transactions for a particular merchant are accessed by the server 312. For example, using this user or consumer transaction information, the server may be able to identify and log, for the particular merchant, a number or percentage of denied/authorized transactions, the merchant's sales volume, the merchant's sales growth, the merchant's sales velocity (i.e., expected or projected sales target), etc. Referring to FIG. 3B, the server may also access (e.g., from a database) 313 additional metrics such as the stored transaction management and security data (e.g., consumer credit check procedures at POS, POS-type, secure online purchase sites, etc.) provided to the server by the merchant, as well as the merchant's other stored performance metrics 314 (e.g., fraud rate, charge backs, copy requests, etc.). Additionally, the server accesses historical merchant transaction rates (e.g., interchange rate) 315 in order to determine, for example, whether the merchant is eligible for receiving any discounts associated with their current transaction rate. For example, if the merchant has successively improved their performance metric figures (e.g., reduced fraud rate, reduced charge backs, increased merchant credit rating, increased sales volume, increased sales growth, etc.), in response to this trend, they may be entitled to receive a discounted or reduced transaction rate. The stored historical merchant transaction rates may also include a base transaction rate that is set for the merchant. The base transaction rate may be set by the payment processor either individually or in collaboration with other financial entities such as issuing and/or acquirer banks. The base transaction rate may, for example, be set to include the last updated transaction rate for the merchant, an average of the last N (i.e., N=2 to any predetermined integer amount) transaction rates for the merchant, or the first base transaction rate initially assigned to the merchant. Each on the above accessed metrics is identified for processing 328. For example, a fraud rate adjustment type and a copy request adjustment type may be identified.

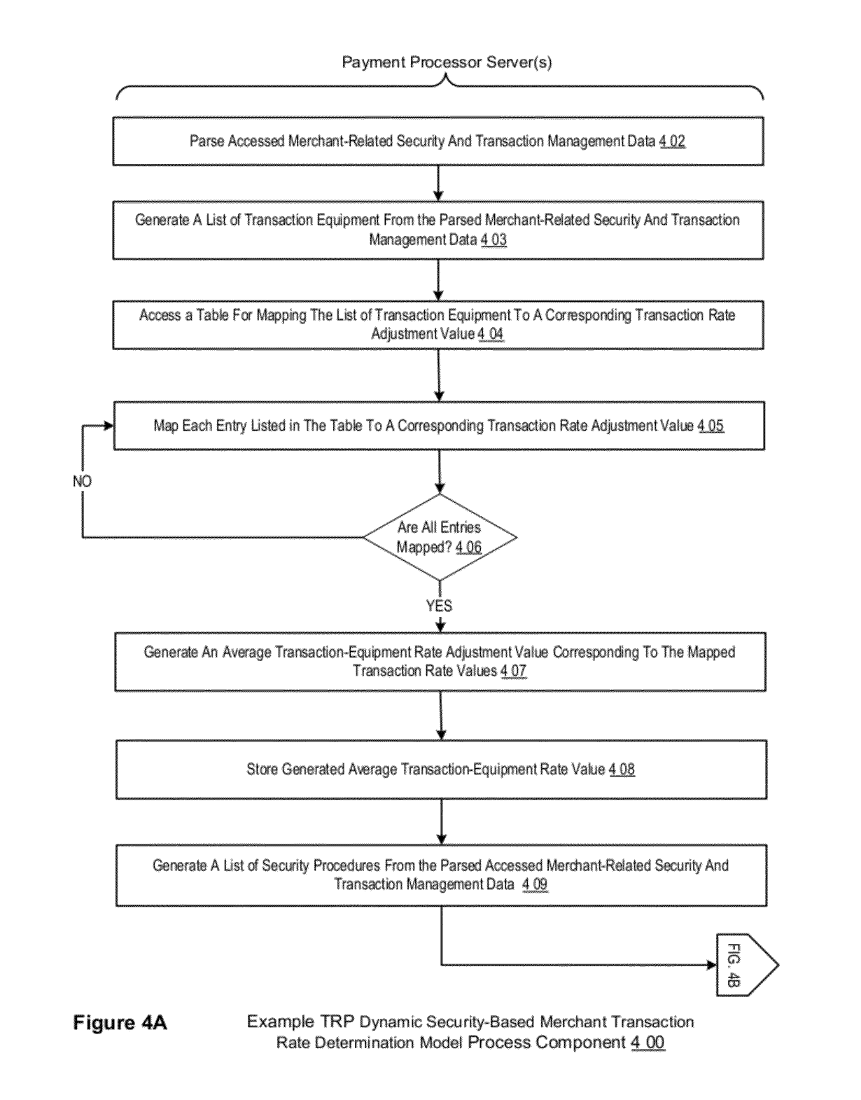

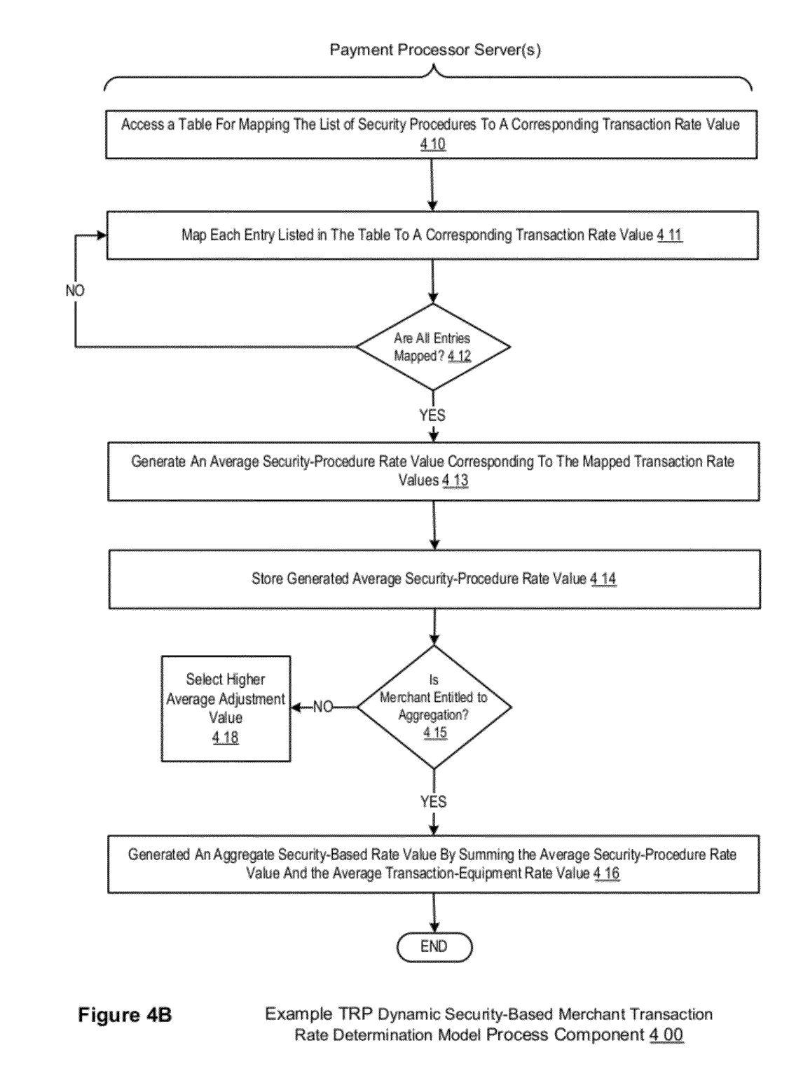

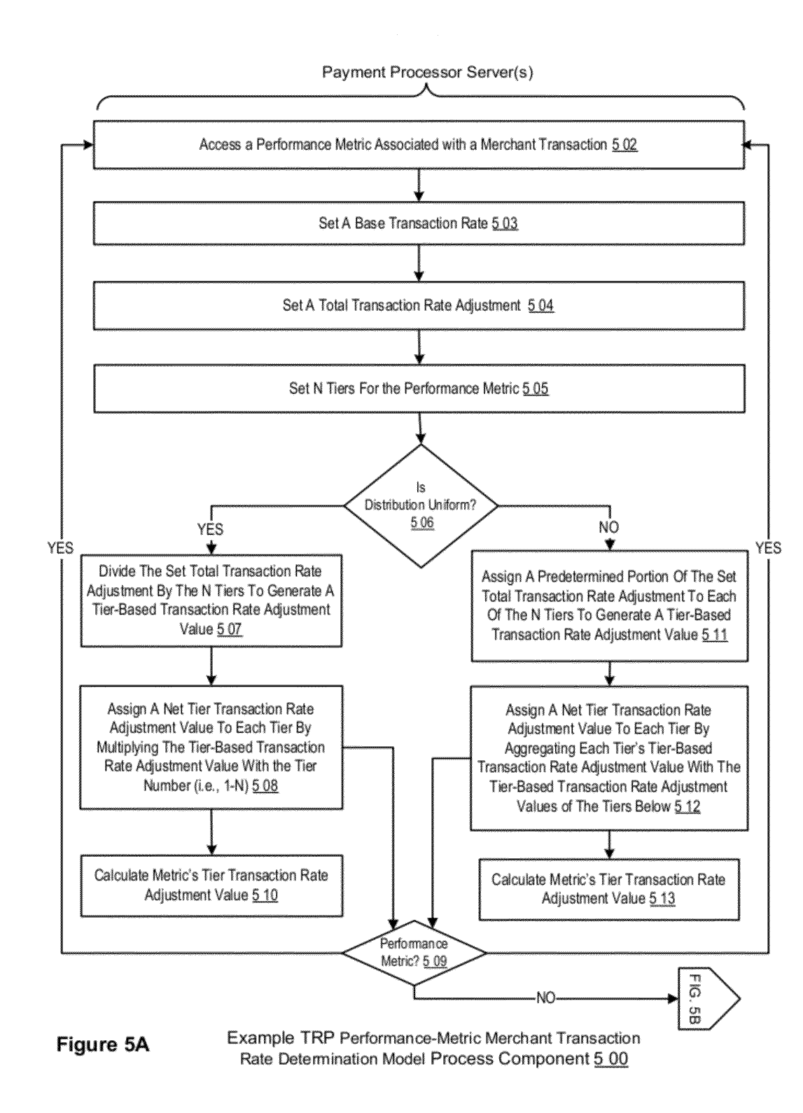

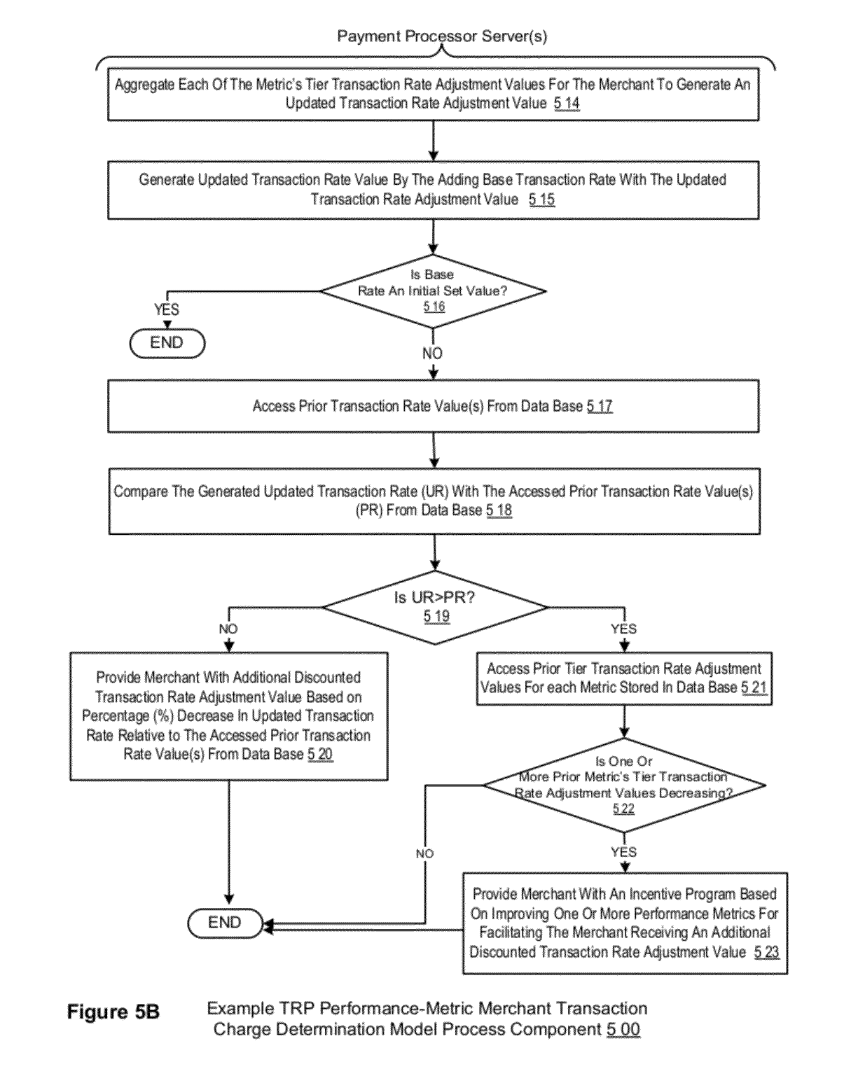

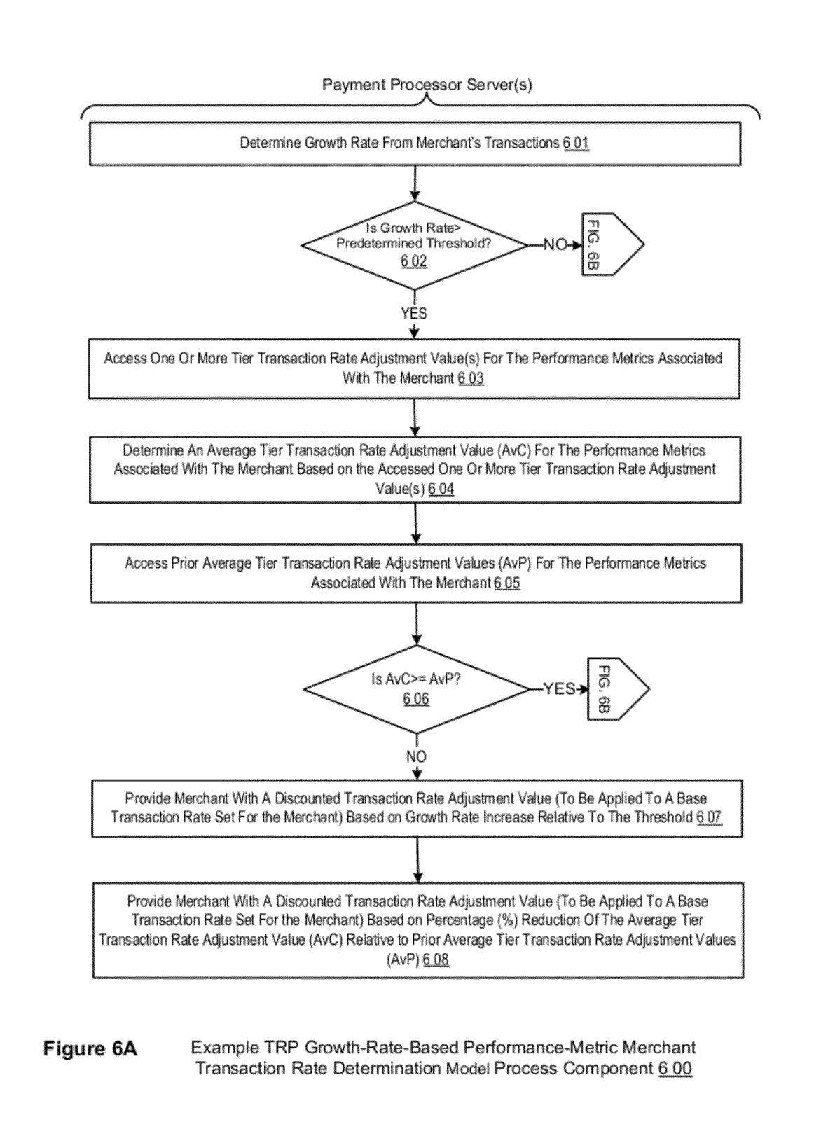

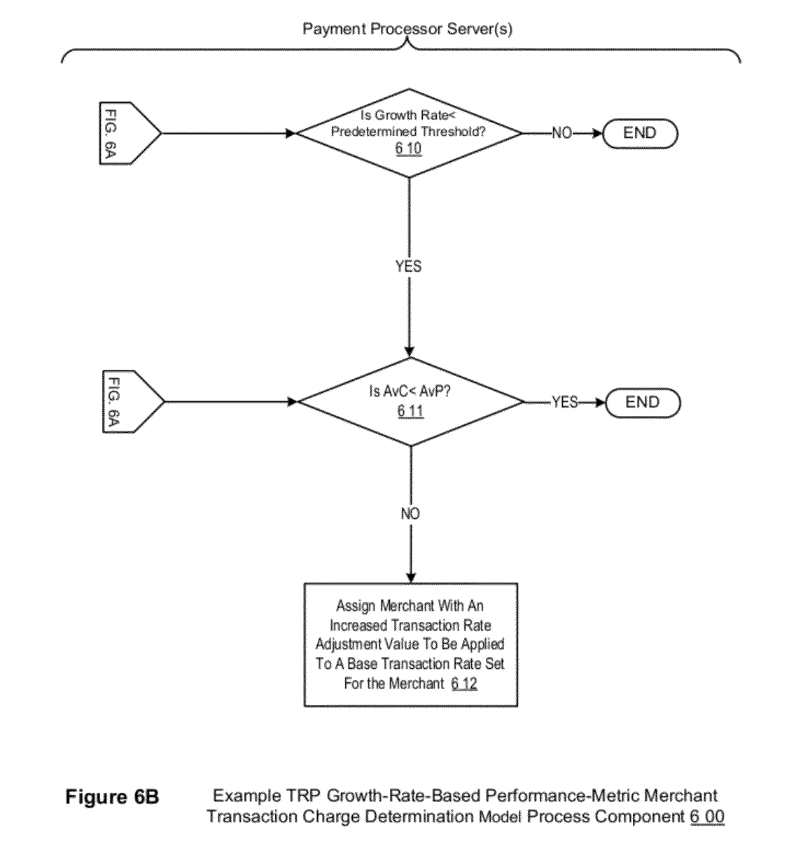

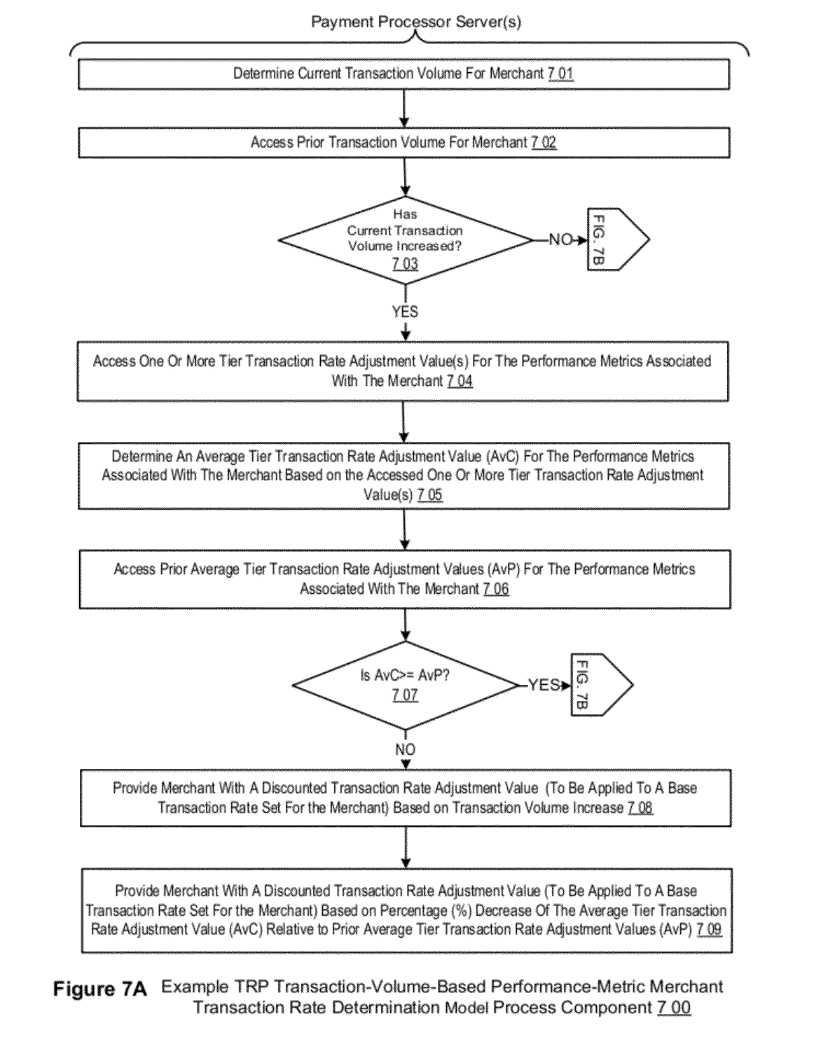

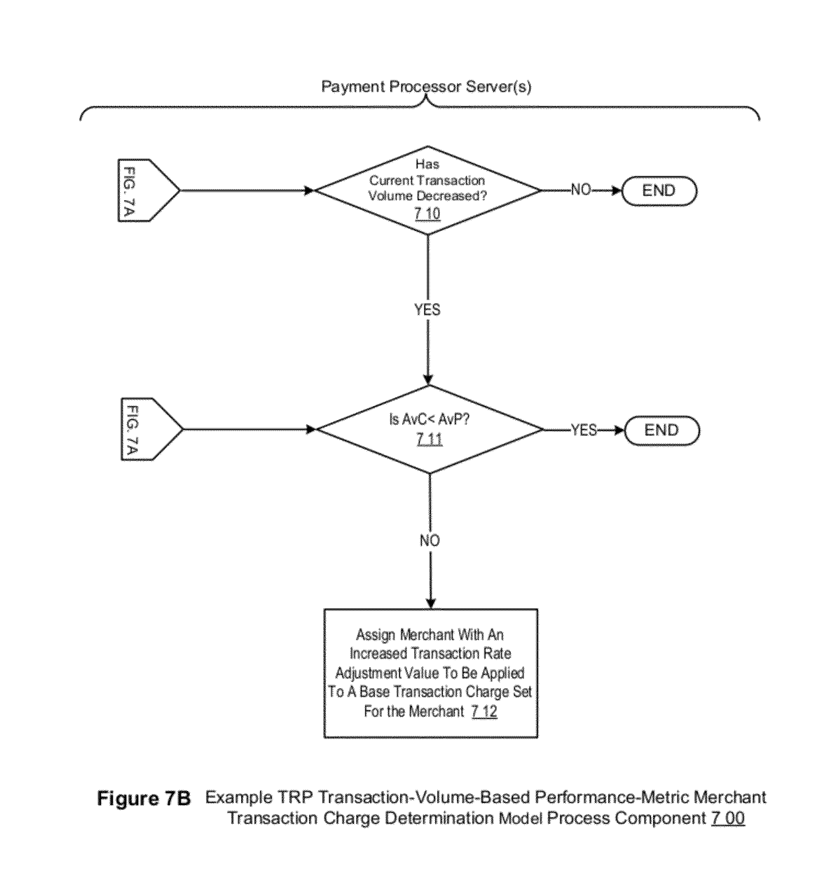

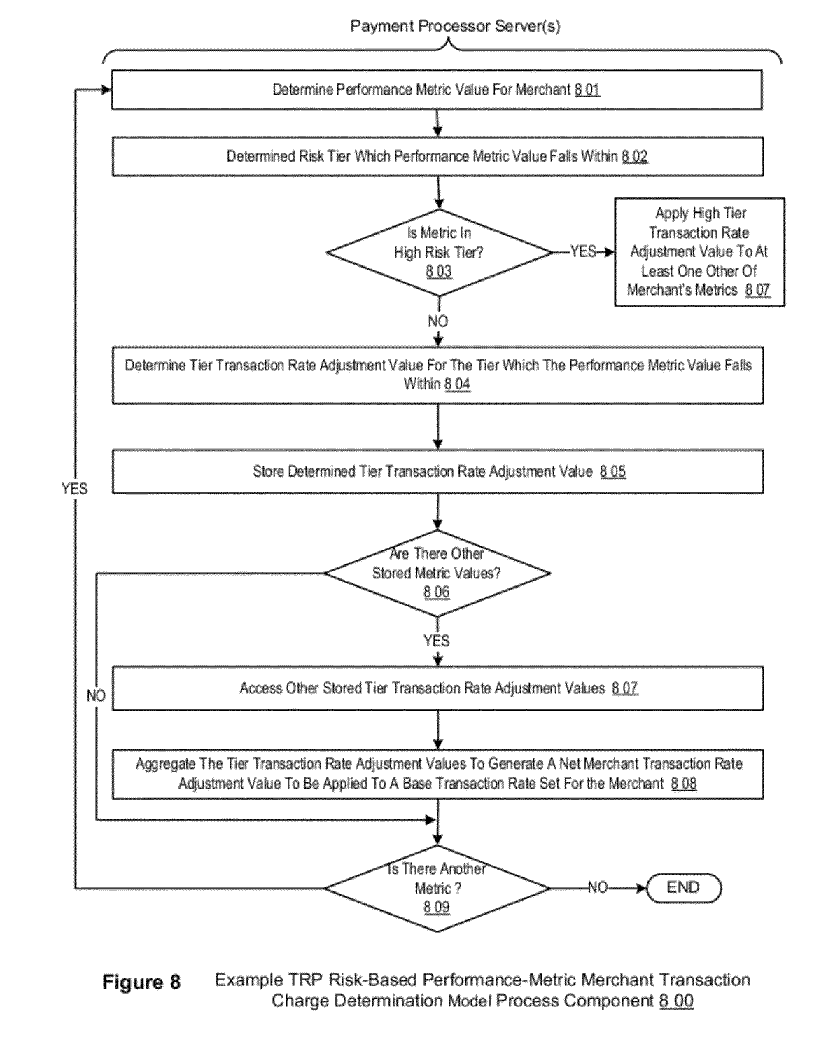

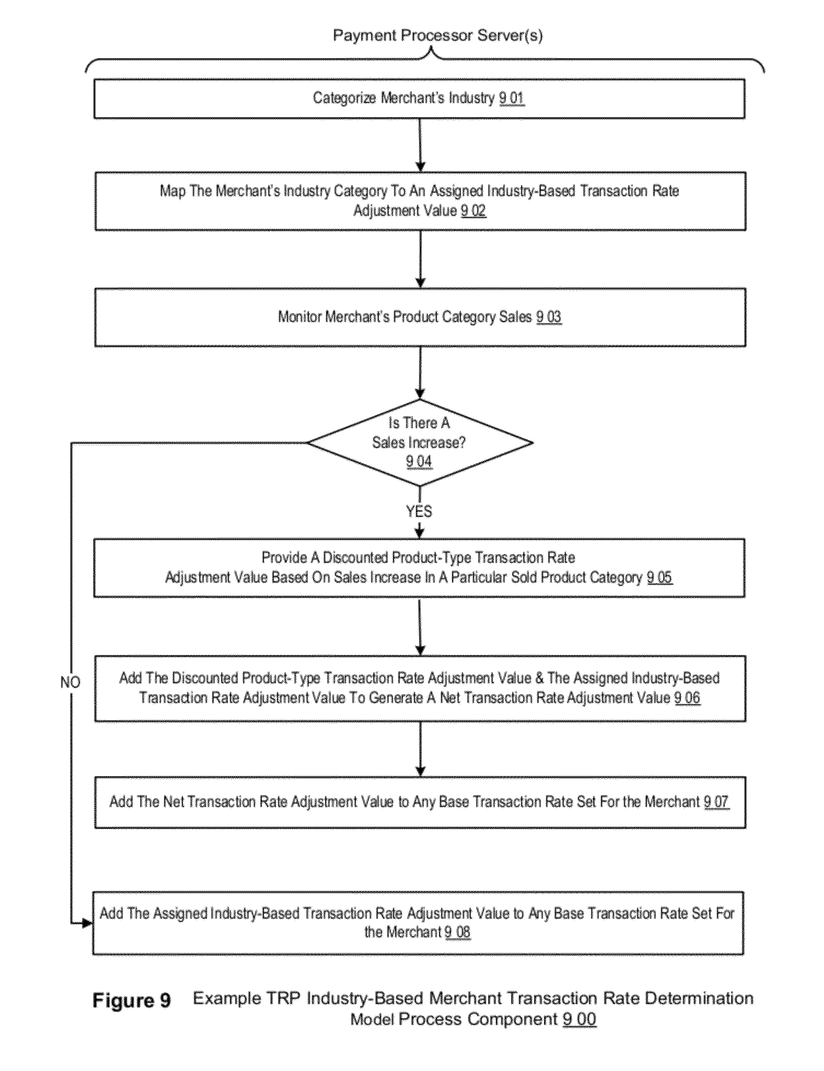

The server then generates, via one or more dynamic merchant transaction rate determination mechanisms (e.g., FIGS. 4-9) 317, a merchant transaction rate based on processing the identified accessed adjustment types associated with the accessed merchant transaction information 312, merchant-related Security and/or transaction management data 313, merchant performance metric data 314, and/or merchant transaction rate historical data 315. The generated merchant transaction rate is then sent, via an appropriate channel (e.g., Email, SMS, mobile application, etc.), to the merchant 319. For example, a multimodal gateway may be used to send Email, SMS, MMS, or other message formats to one or more designated contacts (e.g., merchant's CFO, accounting department, etc.) associated with the merchant based on the merchant's preferences (e.g., Email message preference). For example, a fraud rate adjustment value may be calculated and used to determine the merchant's transaction rate. If any other adjustment values have been calculated, these values may be aggregated to generate an updated adjustment value 330. For example, each adjustment component may provide an incremental adjustment value; e.g., the security equipment adjustment component 400 of FIG. 4 may result in an adjustment of −0.001 (e.g., discounted for enhanced security equipment) for increased security equipment determination, and the risk tierage adjustment component 500 of FIG. 5 may result in an adjustment of +0.003 (e.g., increase for heightened risk tier), and therefore the overall updated adjustment value 330 to be applied to the interchange rate would be +0.002. It may then be determined whether one or more other adjustment types may 14 be accessed for processing 332. If for example another adjustment type exists, the next adjustment type (e.g., copy request adjustment type) is accessed 334 for processing 328, 317, 330. The various adjustment values are updated as each adjustment value is calculated to generate the merchants latest transaction rate 319. In some implementations, the adjustment rate determination mechanisms of FIGS. 4-9 may be utilized, whereby FIG. 4 includes a security-equipment-based adjustment component (SEAC) and a security-process-based adjustment component (SPAC), FIG. 5 includes a risk-tierage adjustment component (RTAC), FIG. 6 includes a growth-rate incentive adjustment component (GRIAC), FIG. 7 includes a transaction-volume incentive adjustment component (TVIAC), FIG. 8 includes a high-risk assessment adjustment component (HRAC), and FIG. 9 includes a merchant-industry adjustment component (MIAC).

Based on the processing and mechanisms utilized, it is then additionally determined whether the merchant is eligible to receive incentives for receiving reductions or discounts on the merchant's current transaction rate 320. If the merchant is entitled to receive any reductions or discounts on their current transaction rate, one or more merchant performance targets are generated 322. Once generated, the one or more merchant performance targets are sent to the merchant 323. For example, the one or more merchant performance targets may include a transmitted message such as “Reduce and maintain your fraud occurrences on credit and debit cards by no more than 10 instances this month and you will be eligible to receive a 0.004% reduction in your current transaction rate—Based on you current sales volume, this is a saving of $xx.xx per month.” In some implementation, the merchant may also receive graphs and charts that are indicative of the incentives and corresponding performance requirements of the merchant.

FIGS. 4A-4B are of block diagrams 400 illustrating example aspects of a transaction rate determination model associated with merchant security in some embodiments of the TRP. This determination model includes a security-equipment-based adjustment component (SEAC) and a security-process-based adjustment component (SPAC). At the payment processor server (e.g., 216), the received security and transaction management data associated with the merchant is parsed 402 in order 22 to generate a first list corresponding to the merchant's transaction equipment (e.g., POS type) and a second list associated with the merchant's security and transaction management data (e.g., security checking procedures during transactions) 403.

One or more mapping tables are then accessed to map the list of the merchant's transaction equipment to a corresponding transaction rate adjustment value (e.g., discount of −0.005% or rate increase of +0.0055%) 404. The listed first piece of equipment is then mapped to the table entries to determine a corresponding transaction rate adjustment value 405. It is then determined whether more equipment associated with the merchant is listed 406. If so, the next listed piece of equipment is mapped to the table entries to determine a corresponding transaction rate adjustment value 405. If all the listed equipment of the merchant is mapped 406, the mapped transaction rate adjustment values for the merchant's transaction equipment are averaged 407, where the average transaction-equipment rate adjustment value for the merchant is stored 408.

Based on the parsing 402 a second list associated with the merchant's security and transaction management data (e.g., security checking procedures during transactions) is also generated 409. Referring to FIG. 4B, one or more mapping tables are then accessed to map the list of the merchant's security and transaction management data to a corresponding transaction rate adjustment value (e.g., discount of −0.0045% or rate increase of +0.0070%) 410. The first listed security and transaction management data is then mapped to the table entries to determine a corresponding transaction rate adjustment value 4011. It is then determined whether more security and transaction management data is listed 412. If so, the next listed security and transaction management data is mapped to the table entries to determine a corresponding transaction rate adjustment value 411. If all the listed security and transaction management data of the merchant is mapped 412, the mapped transaction rate adjustment values for the merchant's security and transaction management data are averaged 413, where the average security-procedure transaction rate adjustment value for the merchant is stored 414.

It is then determined whether the merchant is entitled to aggregate both the average transaction rate adjustment value of the security and transaction management data and the average transaction rate adjustment value of the merchant's transaction equipment 415. If the merchant is entitled to aggregation, in such an implementation, an increase in one average adjustment value may be offset by a reduction in the other. Thus, the average transaction rate adjustment value of the security and transaction management data is summed with the average transaction rate adjustment value of the merchant's transaction equipment 416. However, in other implementations, the higher one of the average transaction rate adjustment values of the merchant's security and transaction management data and the merchant's transaction equipment is selected for processing 418.

Once the average adjustment values are generated, they may be stored for processing and aggregation with one or more of the other adjustment values determined from the other determination modules (i.e., FIGS. 5-9). Alternatively, for example, the generated aggregate average adjustment values for the merchant may be added to a merchant's base transaction rate or a merchant's existing transaction rate without considering other merchant performance metrics.

FIGS. 5A-5B are of block diagrams illustrating example aspects of a transaction rate determination model associated with merchant performance-metrics in some embodiments of the TRP. This determination model includes a risk-tierage adjustment component (RTAC). The payment processor server (e.g., 206) may access a merchant's performance metric (e.g., fraud rate) to be used in the processing and determination of a transaction rate adjustment value (i.e., an increase indicative of a penalty or a decrease indicative of a discount) 502. A base transaction rate is then set 503 for the merchant, where based on the performance metric values determined for the merchant, the base transaction rate is increased or decrease accordingly. A total transaction rate adjustment value is also set 504.

A number (e.g., N) of tiers is set for the performance metric 505. For example, in some implementations three (3) tiers indicative of a low risk tier, a medium risk tier, and a high risk tier may be selected. It then determined whether the set tiers are to be distributed over the total transaction rate adjustment value in a uniform value, or whether different tiers are to include different assigned adjustment values based on the total transaction rate adjustment value 506. For example, for a total transaction rate adjustment value of 0.09% and three (3) tiers, under a uniform distribution scheme, tier-1 includes a transaction rate adjustment value of 0.03%, tier-2 includes an adjustment value of 0.06%, and tier-3 includes an adjustment value of 0.09%. Thus, the 0.09% total transaction rate adjustment value is distributed evenly among the tiers.

If a uniform distribution is applied 506, the total transaction rate adjustment value is divided by the set tiers to generate a tier-based transaction based adjustment value 507. For example, for a total transaction rate adjustment value of 0.09% and three (3) tiers, a tier-based transaction based adjustment value of 0.09%/3=0.03% is generated.

Each tier level (e.g., 1, 2, and 3) is then multiplied by the generated tier-based transaction based adjustment value (e.g., 0.03%) to determine a net tier transaction rate adjustment value for each tier level. The net tier transaction rate adjustment value may be an assigned adjustment value with each tier 508.

For example, for tier-1, the tier number (1) is multiplied by the tier-based transaction based adjustment value of 0.03%. Thus, for tier-1, the net tier transaction rate adjustment value is 0.03%, which is the assigned rate within tier-1. Similarly, for example, for tier-2, the tier number (2) is multiplied by the tier-based transaction based adjustment value of 0.03%. Thus, for tier-2, the net tier transaction rate adjustment value is 0.06%, which is the assigned rate within tier-2. Also, for example, for tier-3, the tier number (3) is multiplied by the tier-based transaction based adjustment value of 0.03%. Thus, for tier-3, the net tier transaction rate adjustment value is 0.09%, which is the assigned rate within tier-3.

Once the adjustment values are assigned to each tier level, for a particular metric, the rate of occurrence of that metric for the particular merchant is determined from data that is stored and processed by the payment processor. For example, for fraud rate, if the rate of occurrence for various merchants varies from 0-100 instances per year, this range of fraud occurrence may be assigned to the different transaction rate adjustment tiers. For example, 0-33 fraud occurrences may be assigned to the low risk tier-1 level, 34-66 fraud occurrences may be assigned to the medium risk tier-2 level, and 67-100 fraud occurrences may be assigned to the high risk tier-3 level.

As described in the above paragraphs, each tier level has an assigned net tier transaction rate adjustment value. Based on the above examples, if the merchant has a fraud occurrence of 60 instances of fraud, they fall within tier-2. Tier-2 has, for example, an assigned net tier transaction rate adjustment value 0.06%. Therefore, the tier transaction rate adjustment value calculated for the merchant 510, based on the fraud metric, is 0.06%. The process continues in the same or similar manner in order to calculate the merchant's adjustment values for other performance metrics (e.g., charge backs, copy requests, etc.).

If a non-uniform distribution is applied 506, a predetermined portion of the set total transaction rate adjustment value is applied to the set tiers to generate a tier-based transaction adjustment value 511. For example, for a total transaction rate adjustment value of 0.09% and three (3) tiers, a tier-based transaction based adjustment value may be distributed in a manner whereby tier-1 has a predetermined portion of the set total transaction rate adjustment value of 0.01%, tier-2 has a predetermined portion of the set total transaction rate adjustment value of 0.03%, and tier-3 has a predetermined portion of the set total transaction rate adjustment value of 0.05%.

In order to generate a net tier transaction rate adjustment value for each tier, the tier's predetermined portion of the set total transaction rate adjustment value is aggregated with the lower tier's predetermined portion of the set total transaction rate adjustment value to generate a net tier transaction rate adjustment value 512. For example, for tier-1, since there is no lower tier, the net tier transaction rate adjustment value is the predetermined portion of the set total transaction rate adjustment value for tier-1, which in the current example is 0.01%. For example, for tier-2, the net tier transaction rate adjustment value is the predetermined portion of the set total transaction rate adjustment value for tier-2, which in the current example is 0.03%, aggregated with the predetermined portion of the set total transaction rate adjustment value for tier-1, which in the current example is 0.01%. Thus, for tier-2, the net tier transaction rate adjustment value is 0.01%+0.03%=0.04%. Also, for tier-3, the net tier transaction rate adjustment value is the predetermined portion of the set total transaction rate adjustment value for tier-3, which in the current example is 0.05%, aggregated with the predetermined portions of the set total transaction rate adjustment values for tier-2 and tier-3, which in the current example are 0.01% & 0.03%, respectively. Thus, for tier-3, the net transaction rate adjustment value is 0.01%+0.03%+0.05%=0.09%.

Once the net tier adjustment values are assigned to each tier level, for a particular metric, the rate of occurrence of that metric for the particular merchant is determined from data that is stored and processed by the payment processor. For example, for fraud rate, if the rate of occurrence for various merchants varies from 0-100 instances per year, this range of fraud occurrence may be assigned to the different transaction rate adjustment tiers. For example, 0-33 fraud occurrences may be assigned to the low risk tier-1 level, 34-66 fraud occurrences may be assigned to the medium risk tier-2 level, and 67-100 fraud occurrences may be assigned to the high risk tier-3 level.

As described in the above paragraphs, each tier level has an assigned net tier transaction rate adjustment value. Based on the above examples for non-uniform distribution, if the merchant has a fraud occurrence of 75 instances of fraud, they fall within tier-3. Tier-3 has, for example, an assigned net tier transaction rate adjustment value 0.09%. Therefore, the tier transaction rate adjustment value calculated for the merchant 513, based on the fraud performance-metric, is 0.09%. The process continues in the same or similar manner in order to calculate the merchant's net adjustment values for other performance metrics (e.g., charge backs, copy requests, etc.).

Referring to FIG. 5B, each of the tier transaction rate adjustment values calculated for the merchant's performance metrics is aggregated to generate an updated transaction rate adjustment value of the merchant 514. In some implementations, the assigned net tier transaction rate adjustment values for each tier may include a negative value indicative of a discount or reward for being within a low risk tier. For example, the tier-1 value may have a −0.03% value instead of a +0.03% value, whereby during aggregation, the negative value(s) (i.e., −0.03%) facilitates offsetting any positive values associated with other merchant performance metrics. The updated transaction rate adjustment value of the merchant is then added to the merchant's set base transaction rate in order to generate an update transaction rate value for the merchant 515.

If it is determined that the set base transaction rate was an initial value set for the merchant (i.e., no prior transaction rate values for the merchant), no further action is taken 516. If on the other hand, it is determined that the merchant has prior transaction rate values, the merchant's prior transaction rate values (PR) are accessed 517. The generated updated transaction rate value (UR) for the merchant is compared with the accessed prior transaction rate values (PR) of the merchant 518. In some implementations the prior values may be averaged. In other implementations, however, the last prior value is accessed.

If it is then determined that the generated updated transaction rate value (UR) for the merchant is greater than the merchant's prior transaction rate value(s) (PR) 519, the prior tier transaction rate adjustment values for each metric stored in, for example, a database, are accessed 521. It is next determined whether one or more of the accessed prior tier transaction rate adjustment values for each metric is decreasing over time (i.e., towards the current time) 522. If so, the merchant is provided with an incentive program to improve (i.e., decrease) the tier transaction rate adjustment values associated with one or more other performance metrics in order for the merchant to receive an additional discounted transaction rate adjustment value for reducing the merchants updated transaction rate value 523. It is determined that the one or more of the accessed prior tier transaction rate adjustment values for each metric is not decreasing over time (i.e., towards the current time) 522, no action is taken.

If it is determined that the generated updated transaction rate value (UR) for the merchant is less than the merchant's prior transaction rate value(s) (PR) 519, the merchant is provided with an additional discounted (e.g., reduced or negative value) transaction rate adjustment value in proportion to the percentage by which the generated updated transaction rate value (UR) has improved (i.e., is less then) relative to the merchant's prior transaction rate value(s) (PR) 520. The percentage improvement in adjustment value may be based on either the merchant's last prior transaction rate value or an average of the merchant's last prior transaction rate values.

FIGS. 6A-6B are of block diagrams 600 illustrating example aspects of a transaction rate determination model associated with merchant growth-rate in some embodiments of the TRP. This determination model includes a growth-rate incentive adjustment component (GRIAC). The merchant's growth-rate may be determined based on historical transaction data associated with the merchant 601. It is determined whether the merchant's determined growth-rate is higher than a predetermined threshold 602. If the merchant's determined growth-rate is higher than the predetermined threshold 602, one or more tier transaction rate adjustment values associated with the merchant's performance metrics are accessed 603. Once accessed, the one or more tier transaction rate adjustment values associated with the merchant's performance metrics are averaged to determined a current average tier transaction rate adjustment value (AvC) 604. One or more average prior tier transaction rate adjustment values associated with the merchant's performance metrics are also accessed (AvP) 605. In some implementations, the most recent average prior tier transaction rate adjustment value may be selected. In other implementations, several average prior tier transaction rate adjustment values are further averaged to generate a prior tier transaction rate adjustment value.

It is then determined whether the current average tier transaction rate adjustment value (AvC) is greater than or equal to the average prior tier transaction rate adjustment value (AvP) associated with the merchant's performance metrics 606. If not (i.e., AvC is reduced), the merchant is entitled to receive a discounted transaction rate adjustment value based on the proportion or percentage increase in the merchant's growth-rate 607 relative to the predetermined threshold. In addition, the merchant may also receive another discounted transaction rate adjustment value based on the proportion or percentage decrease in the current average tier transaction rate adjustment value (AvC) relative to the average prior tier transaction rate adjustment value (AvP) of the merchant 608. These discounted transaction rate adjustment values may then be aggregated with the merchant's base transaction rate in order to reduce the merchant's updated transaction rate.

Referring to FIG. 6B, if it is both determined that the growth-rate is less than the predetermined threshold value 610, and the current average tier transaction rate adjustment value (AvC) is greater than the average prior tier transaction rate adjustment value (AvP) associated with the merchant's performance metrics 611 (i.e., a reduced metric performance), the merchant may be assigned with an increased transaction rate adjustment value, which is then applied to the merchant's base transaction rate 612.

FIGS. 7A-7B are of block diagrams 700 illustrating example aspects of a transaction rate determination model associated with merchant transaction-volume in some embodiments of the TRP. This determination model includes a transaction-volume incentive adjustment component (TVIAC). The merchant's current transaction volume may be determined 701 based on accessing prior transaction volume information associated with the merchant 702, whereby the transaction volume information is derived from the merchant's prior purchase history. It is then determined whether the merchant's determined transaction volume is higher than the accessed prior transaction volume of the merchant 703. In some implementations, the accessed prior transaction volume of the merchant may include a merchant's last determined transaction volume. In other implementations, the accessed prior transaction volume may include an average of several (i.e., N=2 to a predetermined integer value) prior transaction volume determinations. If the merchant's current determined transaction volume is greater than the prior transaction volume 703, one or more tier transaction rate adjustment values associated with the merchant's performance metrics are accessed 704. Once accessed, the one or more tier transaction rate adjustment values associated with the merchant's performance metrics are averaged to determined a current average tier transaction rate adjustment value (AvC) 705. One or more average prior tier transaction rate adjustment values associated with the merchant's performance metrics are also accessed (AvP) 706. In some implementations, the most recent average prior tier transaction rate adjustment value may be selected. In other implementations, several average prior tier transaction rate adjustment values are further averaged to generate a prior tier transaction rate adjustment value.

It is then determined whether the current average tier transaction rate adjustment value (AvC) is greater than or equal to the average prior tier transaction rate adjustment value (AvP) associated with the merchant's performance metrics 707. If not (i.e., AvC is reduced), the merchant is entitled to receive a discounted transaction rate adjustment value based on the proportion or percentage increase in the merchant's transaction volume 708 relative to the merchant's prior transaction volume or average prior transaction volume. In addition, the merchant may also receive another discounted transaction rate adjustment value based on the proportion or percentage decrease in the current average tier transaction rate adjustment value (AvC) relative to the average prior tier transaction rate adjustment value (AvP) of the merchant 709. These discounted transaction rate adjustment values may then be aggregated with the merchant's base transaction rate in order to reduce the merchant's updated transaction rate.

Referring to FIG. 7B, if it is both determined that the transaction volume has decreased 710, and the current average tier transaction rate adjustment value (AvC) is greater than the average prior tier transaction rate adjustment value (AvP) associated with the merchant's performance metrics 711 (i.e., a reduced metric performance), the merchant may be assigned with an increased transaction rate adjustment value, which is then applied to the merchant's base transaction rate 712.

FIG. 8 is of a logic flow diagram 800 illustrating example aspects of a transaction rate determination model associated with merchant's risk category in some embodiments of the TRP. This determination model includes a high-risk assessment adjustment component (HRAC). A performance metric (e.g., fraud rate) associated with a merchant is determined 801. Based on the occurrence rate of the performance rate, the risk level within which the performance metric falls is determined 802. If the metric occurrence falls within a high risk tier category 803, the merchant is considered a high risk and a high tier (i.e., high risk) transaction rate adjustment value is applied to one or more of the other performance metrics associated with the merchant 807. If the metric occurrence does not fall within a high risk tier category 803, the tier transaction rate adjustment value for the particular merchant's performance metric is determined 804 and stored 805. It is then determined whether there are other tier transaction rate adjustment values for the merchant's performance metrics 806 (e.g., charge backs, copy requests, merchant credit-rating, etc.). If not, processing ends and the determined tier transaction rate adjustment value may be used to increase or decrease the merchant's base transaction rate value. If it is determined that there are other tier transaction rate adjustment values for the merchant's performance metrics, these adjustment values are accessed 807. The accessed other tier transaction rate adjustment values 807 and the determined tier transaction rate adjustment value 804 are aggregated to generate a net merchant transaction rate adjustment value, which is applied to the merchant's base transaction rate value 808. Based on the merchant's transaction-related performance, the net merchant transaction rate adjustment value may yield a negative number that reduces the merchant's base transaction rate. If it is determined that there are other merchant performance metrics (e.g., merchant's transaction security equipment upgrade) available for evaluation 809, processing returns to 801.

Thus, the current exemplary implementation may provide merchants with an incentive to both keep their performance metrics out of any high-risk tier categories in order to avoid receiving higher transaction rate adjustment values, while also attempting to benefit from earning negative transaction rate adjustment values that may be associated with low-tier (i.e., low-risk) categories.

FIG. 9 is of a logic flow diagram 900 illustrating example aspects of a transaction rate determination model associated with a merchant's industry in some embodiments of the TRP. This determination model includes a merchant-industry adjustment component (MIAC). A merchant industry may be categorized (e.g., electronic goods) 901. The merchant's categorized industry may then be mapped, e.g., via one or more tables, to an assigned industry-based transaction rate adjustment value 902. The merchant's sold product category or categories (e.g., TVs) may also be monitored 903.

A determination is then made as to whether there has been a sales increase in the merchant's sold product category or categories 904. If there has been no sales increase 904, the already assigned industry-based transaction rate adjustment value 902 is added to any base transaction rate set for the merchant 908. For example, merchant industries having a low-risk (e.g., specialized equipment with no-return policy) may be assigned negative (i.e., discounted) transaction rate adjustment values.

If a sales increase occurs 904, a discounted product-type transaction rate adjustment value is provided in proportion to the percentage sales increase value 905. The discounted product-type transaction rate adjustment value and the assigned industry-based transaction rate adjustment value are then added to generate a net transaction rate adjustment value 906. The net transaction rate adjustment value is added to any base transaction rate set for the merchant in order to generate an update transaction rate 907.

### TRP Controller

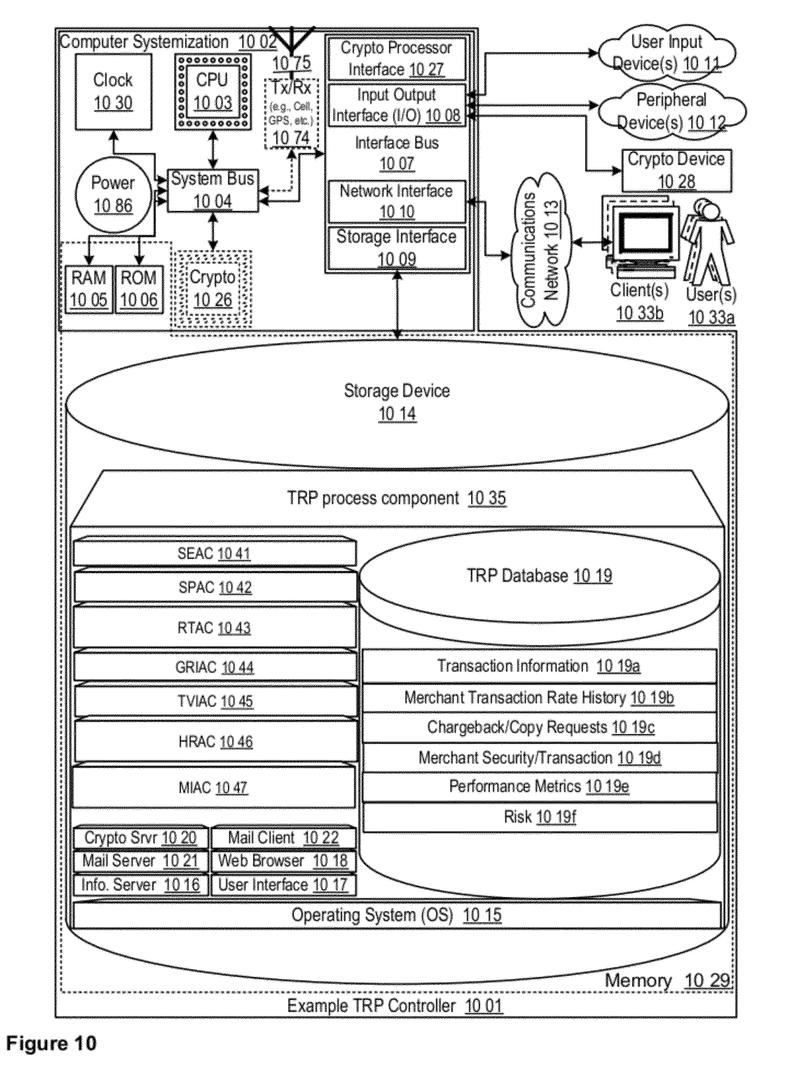

FIG. 10 illustrates inventive aspects of a TRP controller 1001 in a block diagram. In this embodiment, the TRP controller 1001 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to provide various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the TRP controller 1001 may be connected to and/or communicate with entities such as, but not limited to: one or more users from user input devices loll; peripheral devices 1012; an optional cryptographic processor device 1028; and/or a communications network 1013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The TRP controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother)board(s) 1002 having conductive and/or otherwise transportive circuit pathways through which instructions (e.g., binary encoded signals) may travel to effect communications, operations, storage, etc. Optionally, the computer systemization may be connected to an internal power source 1086. Optionally, a cryptographic processor 1026 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the TRP controller and beyond through various interfaces. Should processing requirements dictate a greater amount speed and/or capacity, distributed processors (e.g., Distributed TRP), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the TRP may be achieved by implementing a microcontroller such as CAST's R8051XC2 microcontroller; Intel's MCS 51 (i.e., 8051 microcontroller); and/or the like. Also, to implement certain features of the TRP, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the TRP component collection (distributed or otherwise) and/or features may be implemented via the microprocessor and/or via embedded components; e.g., via ASIC, coprocessor, DSP, FPGA, and/or the like. Alternately, some implementations of the TRP may be implemented with embedded components that are configured and used to achieve a variety of features or signal processing.

Depending on the particular implementation, the embedded components may include software solutions, hardware solutions, and/or some combination of both hardware/software solutions. For example, TRP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the TRP features. A hierarchy of programmable interconnects allow logic blocks to be interconnected as needed by the TRP system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the TRP may be developed on regular FPGAs and then migrated into a fixed version that more resembles ASIC implementations. Alternate or coordinating implementations may migrate TRP controller features to a final ASIC instead of or in addition to FPGAs. Depending on the implementation all of the aforementioned embedded components and microprocessors may be considered the “CPU” and/or “processor” for the TRP.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the TRP thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the TRP controller is accessible through remote clients 1033b (e.g., computers with web 6 browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed TRP), architectures may similarly be employed to pool, load balance, and/or otherwise increase the communicative bandwidth required by the TRP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices loll, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the TRP controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the TRP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the TRP controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); a security-equipment-based adjustment component(s) (SEAC) 1041; a security-process-based adjustment component(s) (SPAC) 1042; a risk-tierage adjustment component(s) (RTAC) 1043; a growth-rate incentive adjustment component(s) (GRIAC) 1044; a transaction-volume incentive adjustment component(s) (TVIAC) 1045; a high-risk assessment adjustment component(s) (HRAC) 1046; a merchant-industry adjustment component(s) (MIAC) 1047; the TRP process component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the TRP controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the TRP controller to communicate with other entities through a communications network 1013. Various communication protocols may be used by the TRP controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the TRP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the TRP database 1019, operating systems, other program components, user interfaces, Web browsers, and/or the like.

Access to the TRP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the TRP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the TRP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the TRP enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the TRP.

Access to the TRP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP₃, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the TRP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD₅ hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to allow the TRP component to engage in secure transactions if so desired. The cryptographic component facilitates the secure accessing of resources on the TRP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The TRP Database

The TRP database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the TRP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the TRP database is implemented as a data-structure, the use of the TRP database 1019 may be integrated into another component such as the TRP component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-e. A Transaction Information table 1019a includes fields such as, but not limited to: consumer_name, consumer_bank account_information, consumer_creditcard_account_information, merchant_ID, merchant_name, merchant_ID purchased_product_description, purchase_price, purchase_date_time, transaction_status, transaction_currency, purchase_item_category_code, transaction_denial_reason, and/or the like. The transaction table may support and/or track multiple merchant transactions on a TRP. A Merchant Transaction Rate History table 1019b includes fields such as, but not limited to: merchant_ID, merchant_name, merchant_current_transaction_rate, merchant_base_transaction_rate, merchant_prior_transaction_rates, transaction_rate_calculation_metrics, transaction_rate_determination_dates, and/or the like. A Chargeback/Copy Requests table 1019c includes fields such as, but not limited to: merchant_ID, chargeback_transaction_ID, chargeback_consumer_name, chargeback_amount, chargeback_date, chargeback_payment_instrument_type, copy_request_transaction_ID, copy_request_consumer_name, copy_request_amount, copy_request_date, copy_request payment_instrument_type and/or the like. A Merchant Security/Transaction Management Information table 1019d includes fields such as, but not limited to: merchant_name, merchant_id, security_check_procedures, transaction_equipment_security_information, and/or the like. A Performance Metrics table 1019e includes fields such as, but not limited to: merchant_ID, merchant_name, metric_, metric_type, metric_adjustment_value, metric_range, and/or the like. A Risk table 1019f includes fields such as, but not limited to: risk_ID, risk_category, merchant_ID, merchant_name, merchant_industry, merchant_industry_based adjustment_value, growth_rate_adjustment_value, transaction_volume_adjustment_value, merchant_base_transaction_rate, performance_metric_tier_level_adjustment value and/or the like. In one embodiment, the TRP database may interact with other database systems. For example, employing a distributed database system, queries and data access by search TRP component may treat the combination of the TRP database, an integrated data security layer database as a single database entity.

In one embodiment, user programs may contain various user interface primitives, which may serve to update the TRP. Also, various accounts may require custom database tables depending upon the environments and the types of clients the TRP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-e. The TRP may be configured to keep track of various settings, inputs, and parameters via database controllers.

The TRP database may communicate to and/or with other components in a component collection, including itself, and/or facilities of the like. Most frequently, the TRP database communicates with the TRP component, other program components, and/or the like. The database may contain, retain, and provide information regarding other nodes and data.

### The TRPs

The TRP process component 1035 is a stored program component that is executed by a CPU. In one embodiment, the TRP component incorporates any and/or all combinations of the aspects of the TRP that was discussed in the previous figures. As such, the TRP affects accessing, obtaining and the provision of information, services, transactions, and/or the like across various communications networks.

The TRP component transforms merchant transaction-related information, merchant performance metrics, merchant security/management information, merchant risk-based information, and merchant industry-based information inputs via one or more of SEAC 1041, SPAC 1042, RTAC 1043, GRIAC 1044, TVIAC 1045, HRAC 1046, and MIAC 1047 components into generated merchant transaction rate and merchant transaction rate incentive outputs that are distributed to individual merchants.

The TRP component providing access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the TRP server employs a cryptographic server to encrypt and decrypt communications. The TRP component may communicate to and/or with other components in a component collection, including itself, and/or facilities of the like. Most frequently, the TRP component communicates with the TRP database, operating systems, other program components, and/or the like. The TRP may contain, communicate, generate, obtain, and/or provide program component, system, user, and/or data communications, requests, and/or responses.

### Distributed TRPs

The structure and/or operation of any of the TRP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the TRP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c -post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the TRP controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

### TRP Interchange Rate Embodiments & Description

In certain implementations, calculations can be made of performance-based interchange rates for individual merchants for the purpose of improving the overall transaction processing system. The performance-based interchange rates are based on factors that may incur a cost to the overall financial system (i.e., a negative effect) and/or provide a benefit to the overall financial system (i.e., a positive effect). For example, in certain implementations, the performance-based interchange rates are derived from the occurrence of events that represent a cost to the financial system, such as charge backs, copy requests, and fraud. In certain implementations, other metrics that represent a cost to the financial system may be used. In other implementations, the performance-based interchange rates are derived from factors that represent a benefit to the financial system, such as a high transaction volume (in terms of aggregate transaction currency amount) and growth rate (in terms of the growth of aggregate transaction currency amount). In yet other implementations, the performance-based interchange rates are derived from both factors that represent a cost and from factors that represent a benefit to the financial payments processing system. The performance-based interchange rates are also based on a model that defines the criteria for establishing tiers for each positive and negative effect as well as the overall interchange rate discount or penalty. In one implementation, the model defines three negative effects: fraud, chargebacks, and copy requests.

Each negative effect is divided into three tiers: low occurrence of the effect, medium occurrence of the effect, and high occurrence of the effect. In one implementation, the value for each negative effect is in terms of currency percentage of the value of the negative effect as a portion of the overall settlement volume. For example, in one implementation, the value for fraud is calculated by the total currency amount attributable to fraud for a given merchant over the total settlement currency amount for that merchant over the same time period.

In one implementation, the model defines five volume tiers: tier 1 (the highest volume) to tier 5 (the lowest volume). In one implementation, the model defines more than five volume tiers. In one implementation, the model defines less than five volume tiers.

In one implementation, the model defines three growth tiers: tier 1 (the highest growth rate) to tier 4 (no growth). In one implementation, the model defines more than three growth tiers. In one implementation, the model defines less than three growth tiers. In certain implementations, the method can be used to improve the performance of the overall financial payments processing system by providing incentives to specific merchants to reduce the level of negative effects under their control. The incentives take the form of interchange rate discounts, which reward a low level of negative effects and high level of positive effects, and rate penalties, which penalize a high level of negative effects.

In certain implementations, the method can be used to model the financial impact on each participant in the financial system based on estimates of future growth and the predicted response to the performance-based incentives.

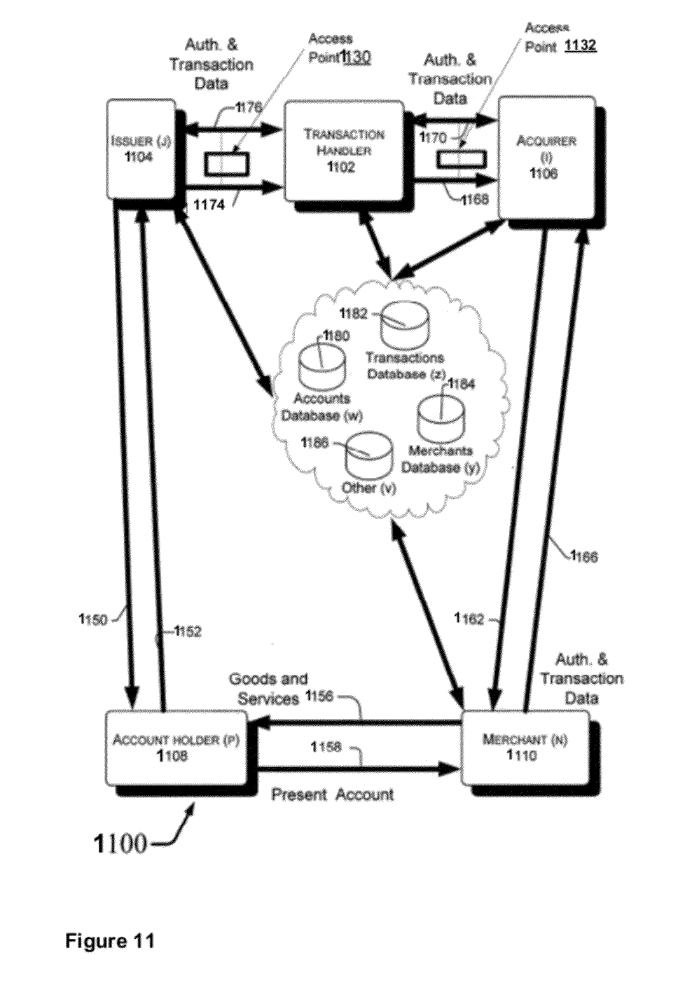

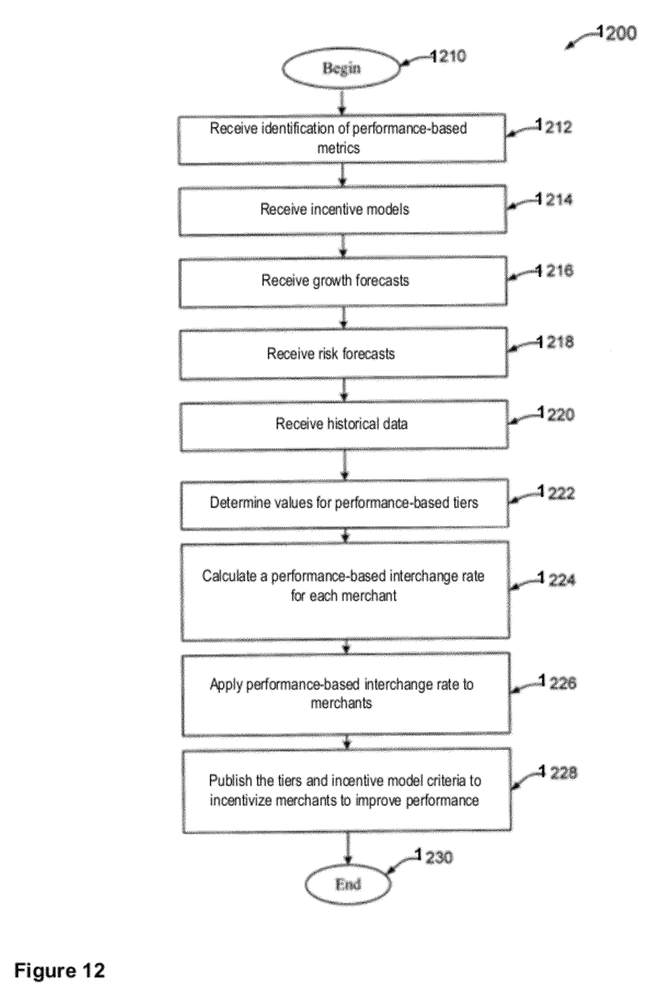

Turning to FIG. 12, a flowchart 1200 illustrating an exemplary method is depicted for calculating performance-based interchange rates and incentivizing a merchant to reduce risk. The merchant is one of a plurality thereof in payment processing system having acquirer and issuers of account to account holders. An exemplary payment processing system 1100 is depicted in FIG. 11 and is discussed below.

The method of flowchart 1200 begins at 1210. In 1212, the method receives specific performance-based metrics that will be calculated from the merchant's past performance. In different implementations, the performance-based metrics include fraud rate, chargeback rate, copy request rate, merchant credit rating, the merchant's percentage of card-not-present transactions, or a combination of two or more of these metrics. In other implementations, the performance-based metrics may include other indicators of merchant behavior that is likely to expose the other participants of the financial payments processing system to increase financial risk. In 1214, the method receives an incentive model. In one implementation, the incentive model includes a base interchange rate. The base interchange rate is set by the transaction handler in collaboration with the issuer and acquirer. The base interchange rate represents the starting value of the model. The final interchange rate for a merchant is calculated by adding any discounts and/or penalties to the base interchange rate. The value of the base interchange rate may be any percentage that the transaction handler chooses. In one implementation the base interchange rate is 1.25%. In another implementation, the base interchange rate is 2.0%.

In another implementation, the base interchange rate is the average interchange rate used by the transaction handlers before the method in FIG. 12 is applied. In one implementation, the incentive model includes the number of tiers for each performance-based metric, the number of tiers for volume discounts, and the number of tiers for growth discounts. In one implementation, each performance-based metric has three tiers: high, middle, and low. In one implementation, there are more than three tiers for each performance-based metric. In one implementation, a given performance-based metric may have more or less tiers than another performance-based metric. In one implementation, there are five volume tiers; merchants with the highest volume are placed in volume tier 1, whereas merchants with the lowest volume are placed in volume tier 5. In one implementation, the number of volume tiers is less than or greater than five. In one implementation, there are four growth tiers; merchants with the highest positive growth are placed in growth tier 1, whereas merchants with no little or no positive growth are placed in growth tier 4.

In one implementation, the incentive model includes a high risk tier adjustment. The high risk tier adjustment is in the form of a positive percentage value that is added to the base interchange rate. This increase can be viewed as a penalty for negative merchant practices as well as an incentive for good merchant practices. In one implementation, the high risk tier adjustment is 0.4%; however it may be any other positive percentage value depending on the desired level of influence over merchant behavior.

In one implementation, the incentive model includes information as to how the high risk tier adjustment will be distributed over the performance-based metrics, such as fraud, charge backs, and copy requests. In one implementation, the high risk tier adjustment is split evenly over the performance-based metrics. For example, given a high risk tier adjustment of 0.4%, 0.13% (0.4/3) would be assigned to each of the fraud metric, chargeback metric, and copy request metric. If a merchant then fell into the high risk tier for fraud and chargebacks, the merchant's interchange rate would be increased by 0.26% (0.13% for fraud+0.13% for chargebacks) over the base interchange rate and any other discounts and/or penalties. In other implementations, the high risk tier adjustment is split unevenly over the performance-based metrics.

In one implementation, the incentive model includes a low risk tier discount. The low risk tier discount is in the form of a negative percentage value that is applied to the base interchange rate. This increase can be viewed as both a reward and an incentive for good merchant practices. In one implementation, the low risk tier discount is −0.2%; however it may be any other negative percentage value depending on the desired level of influence over merchant behavior.

In one implementation, the incentive model includes information as to how the low risk tier discount will be distributed over the performance-based metrics, such as fraud, charge backs, and copy requests. In one implementation, the low risk tier discount is split evenly over the performance-based metrics. For example, given a low risk tier discount of −0.2%, −0.07% (0.2/3) would be assigned to each of the fraud metric, charge back metric, and copy request metric. If a merchant then fell into the low risk tier for fraud and chargebacks, the merchant's interchange rate would be decreased by 0.14% (0.07% for fraud+0.07% for chargebacks) over the base interchange rate and any other discounts and/or penalties.

In one implementation, the incentive model includes the maximum volume discount. The maximum volume discount is a negative percentage value that is applied to a merchant's interchange rate and may be viewed as a reward for those merchants in the highest volume discount tier (i.e., those conducting the highest currency volume on the financial transaction system). In one implementation, the maximum volume discount is −0.31%, however, the maximum volume discount may be any negative percentage value to achieve the desired discount level for high volume merchants. In one implementation, the discount volume for the lower volume discount tiers is reduced linearly, based on currency volume. For example, given a maximum volume discount rate of −0.2%, a volume tier 1 threshold at $1,000, and a volume tier 2 threshold at $500, merchants with a volume at or over $1000 (i.e., those in tier 1) will receive the full discount of 0.2% subtracted from the base interchange rate. Additionally, merchants with a volume at or above $500 and below $1000, will receive the smaller discount of 0.1% subtracted from the base interchange rate. This is calculated by: ($500*0.2%)/$1000=0.1%.

In one implementation, the incentive model includes the maximum growth discount. The maximum growth discount is a negative percentage value that is applied to a merchant's interchange rate and may be viewed as a reward for those merchants in the highest growth tier (i.e., those with the highest rate of growth in terms of currency volume on the financial transaction system). In one implementation, the maximum growth discount is 0.21%; however, the maximum growth discount may be any negative percentage value to achieve the desired discount level for high growth merchants. Only merchants in the top growth tier receive the maximum growth discount. Merchants in the lower growth tiers receive a lower discount that is reduced linearly in the same manner as described for volume discounts above, but as a function of growth rate.

In 1216, the method receives growth forecasts. In one implementation, the growth forecasts are used by the method to estimate the financial impact of the performance-based interchange rate model on issuers, acquirers, and the transaction handler.

In 1218, the method receives risk forecasts. In one implementation, the risk forecasts are used by the method to estimate the financial impact of the performance-based interchange rate model on issuers, acquirers, and the transaction handler.

In 1220, the method receives historical data for each merchant. The historical data is the raw, transaction-level and event-level data for the financial payments processing system, an example of which is seen in FIG. 11. In one implementation, the historical data is extracted from the accounts database (w) 1180, transactions database (z) 1182, and merchants database (y) 1184 of FIG. 1, which are discussed below. In one implementation, the performance-based metrics, volume, and growth values for each merchant are extracted and calculated from the historical data using techniques well known in the prior art. In different implementations, the historical data received may include data from the previous calendar year, the previous fiscal year, or for time periods less than one year. In one implementation, the method will receive historical data from any time span in which the transaction handler wishes to recalculate interchange rates (i.e., monthly, daily, real-time, or near-real-time).

In 1222, the method calculates the specific values (in terms of discount or penalty offset) for each performance-based tier. In one implementation, the values for each tier are set to evenly distribute settlement volume throughout the tiers. For example, consider the fraud metric configured for three tiers: fraud tier 1 (low tier), fraud tier 2 (middle tier), and fraud tier 3 (high tier). With a fraud tier 1 value set at 0.1%, a merchant with a fraud rate of 0.1% or lower will fall into fraud tier 1. Similarly, with a fraud tier 2 value of 0.2%, a merchant with a fraud rate of greater than 0.1% and up to 0.2% will fall into fraud tier 2. Finally, any merchant with a fraud rate greater than 0.2% will fall into fraud tier 3. The values for each tier (in this example, 0.1% and 0.2%) can be selected so that each of the three fraud tiers has an equal currency settlement volume. In other words, the aggregate settlement currency volume for the merchant in tiers 1, 2, and 3 are approximately equal. In another implementation, tiers for the performance based metrics do not have equivalent settle currency volumes.

In 1224, the method determines the performance-based interchange rate for each merchant. In one implementation, once the specific values of each of the performance-based metrics, volume, and growth have been identified for a given merchant, the merchant is placed into the appropriate tiers according to each value. The discounts and penalties corresponding to each tier are then added to the base interchange rate to arrive at a specific performance-based interchange rate for the merchant.

In 1226, the method applies the performance-based interchange rate to each merchant. In 1228, the method publishes the incentive model criteria to the merchants. In one implementation, the model criteria includes an explanation of the performance-based interchange rate and information on the specific improvements a given merchant must make to the various performance metrics to achieve a lower interchange rate. This acts as a financial incentive to the merchant to make the identified improvements. The method ends at 1230.

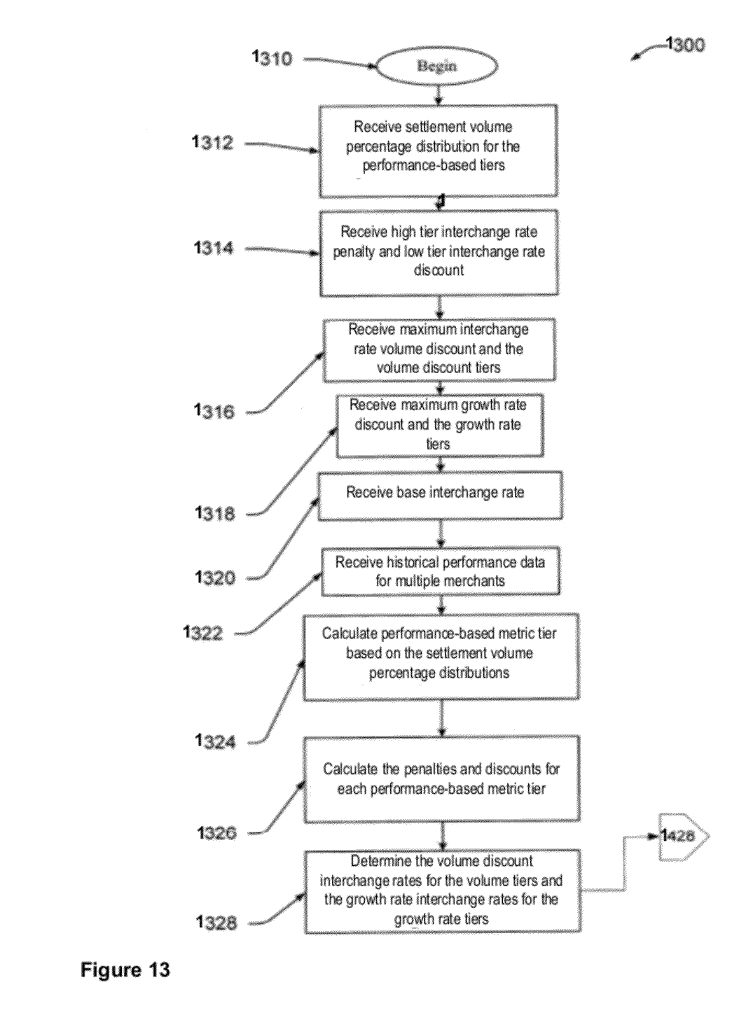

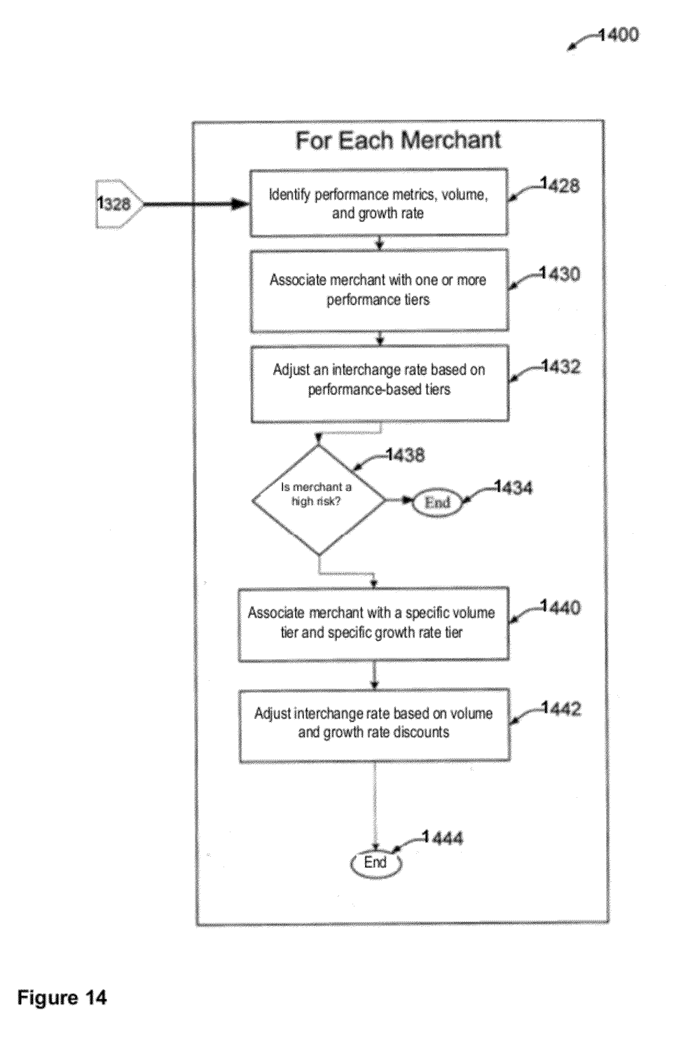

Turning to FIGS. 13 and 14, flowcharts 1300 and 1400 illustrate additional details of the exemplary method of FIG. 12. The method begins at 1310. In 1312-1320, the method receives the performance-based model parameters and raw data. More specifically, in 1312, the method receives distribution of settlement volume across the performance-based metrics. For example, in one implementation, the settlement volume is split evenly (⅓, ⅓, ⅓) across the three performance metrics of fraud, charge backs, and copy requests. In other implementations, the settlement volume is split unevenly across the performance metrics. The distribution of settlement volume across the performance metrics is more fully described in 1214 above.

In 1314, the method receives the high tier interchange rate penalty and low tier interchange rate discount. The high tier interchange rate penalty is the overall penalty percentage applied to merchants in the high tier performance metric groups. The high tier interchange rate penalty and distribution across the performance metrics is more fully described in 1214 above.

In 1316, the method receives the maximum volume interchange rate discount and the volume discount tiers. The maximum volume interchange rate discount is the discount given to merchants with the highest overall currency volume processed through the financial transaction system. The volume tiers are used to identify different volume levels for various volume discount rates. The maximum volume discount and the volume discount tiers are more fully described in 1214 above.

In 1318, the method receives a maximum growth rate discount and the growth rate tiers. The maximum growth rate discount is given to the merchants with the largest growth rates. The growth tiers are used to identify different growth rate levels for various growth discount rates. The maximum growth rate discount and the growth rate tiers are more fully described in 1214 above.

In 1320, the method receives the base interchange rate. The base interchange rate is set by the transaction handler in collaboration with the issuer and acquirer. The base interchange rate represents the starting value of the model. The final interchange rate for a merchant is calculated by subtracting any discounts and/or adding any penalties to the base interchange rate. The value of the base interchange rate may be any percentage that the transaction handler chooses. In one implementation, the base interchange rate is 1.25%. In another implementation, the base interchange rate is 2.0%. In another implementation, the base interchange rate is the average interchange rate used by the transaction handlers before the method of FIG. 13 is implemented.

In 1322, the method receives historical performance information data for multiple merchants. The historical data is the raw transaction-level and event-level data for the financial payments processing system. In one implementation, the historical data is extracted from the accounts database (w) 1180, transactions database (z) 1182, and merchant's database (y) 1184 of FIG. 11. In one implementation, the performance-based metrics, volume, and growth values for each merchant are extracted and calculated from the historical data. In different implementations, the historical data received may include data from the previous calendar year, the previous fiscal year, or for time periods less than one year. In one implementation, the method will receive historical data from a time span that matches the desired updated frequency for the interchange rate (i.e., monthly, daily, real-time, or near-real-time).

In 1324, the method calculates the performance-based metric tiers based on the settlement volume percentage distributions. The values for each performance tier level are determined from the choice of settlement volume across the tiers. For example, with the even distribution in the previous example, the high tier for fraud would be determined by ordering all merchants by fraud rate and defining a cutoff at ⅓ of the overall settlement volume. The identification of performance metric tiers is more fully described in 1214 above.

In 1326, the method calculates the penalties and discounts for each performance-based metric tier. The discounts are negative percentage values and the penalties are positive percentage values. The values for each tier are determined by maximum high tier penalty, low tier discount, and the distribution across performance metrics as described in 1214 above. The total number of discounts and penalties for a given merchant are later added to the base interchange rate to determine an intermediate performance-based interchange rate for that merchant. This performance-based interchange rate will, under some circumstances, be further discounted based on other factors, such as volume and growth.

In 1328, the method determines the volume discount and growth rate tiers. The values for each tier are determined as described in 1214 above. The method then transitions to 1428 on FIG. 14.

The exemplary method illustrated in FIG. 14 is executed for each merchant whose historical performance data was received in 1322. In 1428, the method identifies historical performance metrics, volume, and growth rate for the merchant. In one implementation, the identification of this data involves calculating it from the historical performance data. Based on this information, the merchant is placed in one or more performance tiers in 1430. By way of example, if a merchant's fraud rate is within the high fraud rate tier, the merchant is associated with that tier. In one implementation, the merchant is associated with a high, medium, or low tier for each of the performance metrics of: fraud rate, chargeback rate, and copy request rate. In other implementations, the number of tiers and/or performance metrics may vary.

In 1432, the method adjusts the merchant's interchange rate based on the performance-based tiers in which the merchant is associated. The penalties/discounts for each tier (calculated in 1324) in which the merchant is associated are applied to the base interchange rate.

In 1438, the method determines whether the merchant is a high risk. In one implementation, a merchant associated with at least one high tier is considered a high risk. By way of example, a merchant who is associated with the high copy request tier, but with the low fraud tier and low chargeback tier, is still considered a high risk. If the method determines that the merchant is a high risk, the method ends at 1434. As such, the merchant's interchange rate is determined only by the performance metrics and the merchant is not eligible for volume or growth rate discounts.

If the method determines that the merchant is not a high risk (for example, if the merchant falls into only medium and low performance metric tiers), the method transitions to 1440. In 1440, the method associates the merchant with a volume discount and growth tier based on the merchant volume and growth.

In 1442, the method adjusts the merchant's interchange rate based on the volume and growth tiers in which the merchant is associated. The discounts for each tier (calculated in 1324) in which the merchant is associated are applied to the adjusted interchange rate from 1432. At this point, the final performance-based interchange rate for the merchant is determined. The method ends at 1444.

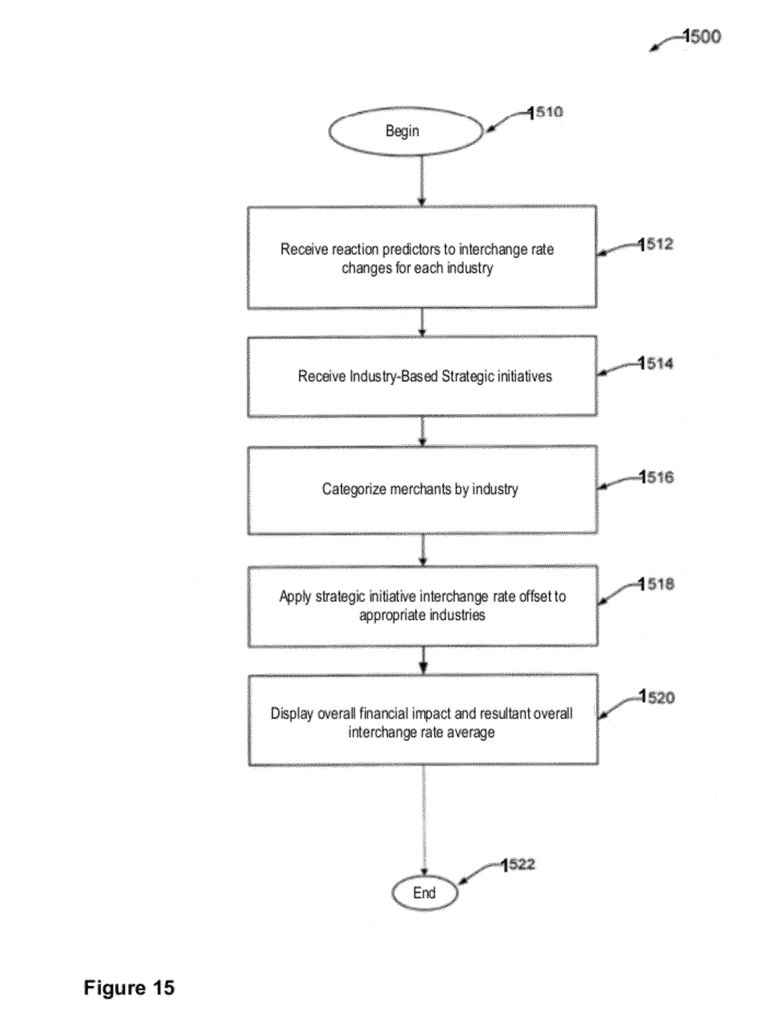

Turning to FIG. 15, a flowchart 1500 illustrating an exemplary method of adjusting the performance-based model to determine the financial impact to one or more participants for the financial transaction system is depicted. The method begins at 1510. In 1512, the method receives reaction predictors to interchange rate changes for each industry. In one implementation, the reaction predictors are based on an each industry's sensitivity to interchange fees. For example, merchants in an industry very sensitive to interchange fees, such as those operating on a very low margin, are likely to modify their commercial behavior in a different way in reaction to the performance-based interchange rate discounts and penalties than merchants an industry that are unaffected by small changes in interchange fees. These assumptions are used to predict the behavioral changes that will occur in reaction to changes in the performance-based model, in particular improvements to the overall financial payment system in response to changes in the performance-based model.

In 1514, the method receives industry-based strategic initiatives. Industry-based strategic initiatives are interchange rate offsets applied to a specific industry to target an entire industry sector for a discount of penalty. In 1516, the merchants are categorized by industry. The industry-based strategic initiative rate offsets are applied (in 1518) to the performance-based interchange rate determined by the model (i.e., in addition to any performance-based, volume, or growth adjustments). Industry-based strategic initiatives can be used to make minor change to the output of the methods in FIG. 12-15 to expand the financial payment system in a particular industry and/or to account for industry-specific factors, such as the financial stability of a particular industry brought about by external forces.

In 1520, the overall financial impact of the reaction predictors and industry-based strategic initiatives is determined and displayed. The average interchange rate across all merchants is also determined and displayed. The method ends at 1522.

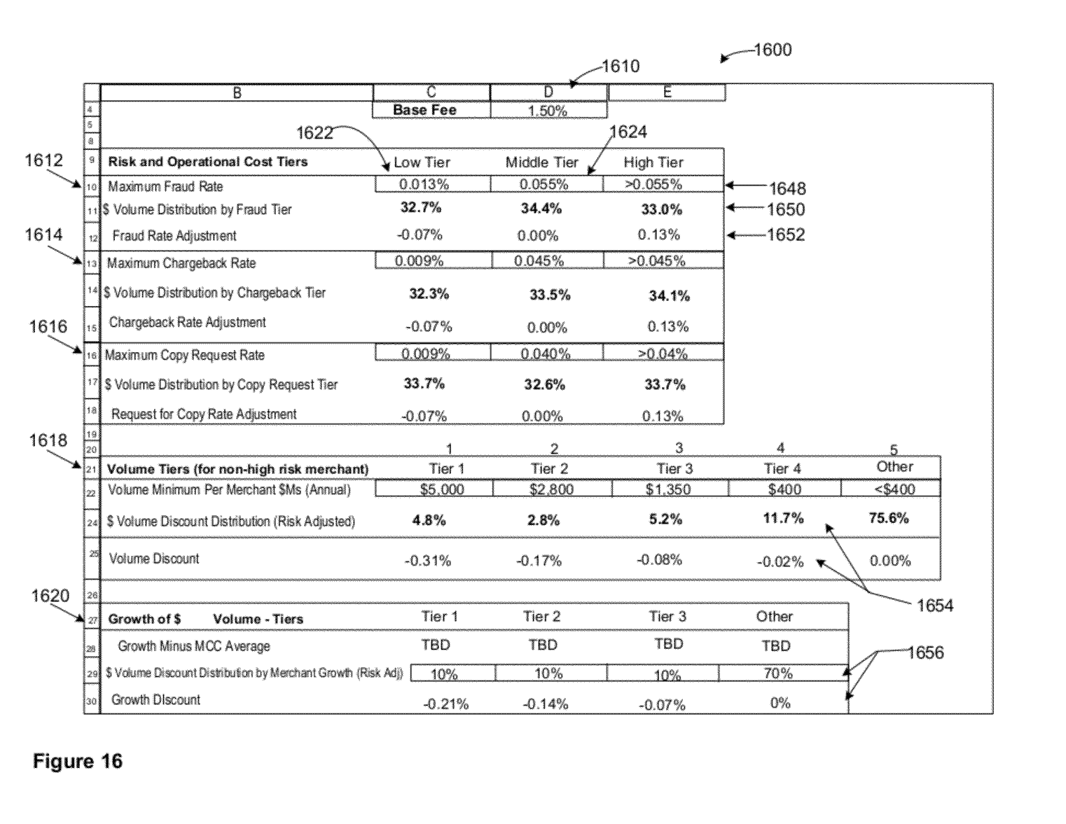

Turning to FIG. 16, an exemplary user interface 1600 for specifying various performance-based model metrics is shown. The existing base interchange rate is shown at 1610. The performance metrics and associated settings are specified at 1612 (for fraud rate), 1614 (for chargeback rate), and 1616 (for copy request rate). Three performance tiers, low, medium, and high, are defined for each performance metric as shown at 1648. For the maximum fraud rate section 1612, the low tier is specified at 1622, the middle tier is specified at 1624, and the high tier is automatically calculated from the middle tier value.

The settlement volume distribution, shown at line 1650, displays the settlement volume calculated from the tier level values 1622 and 1624. In this example, the settlement volume is approximately equal across all tiers.

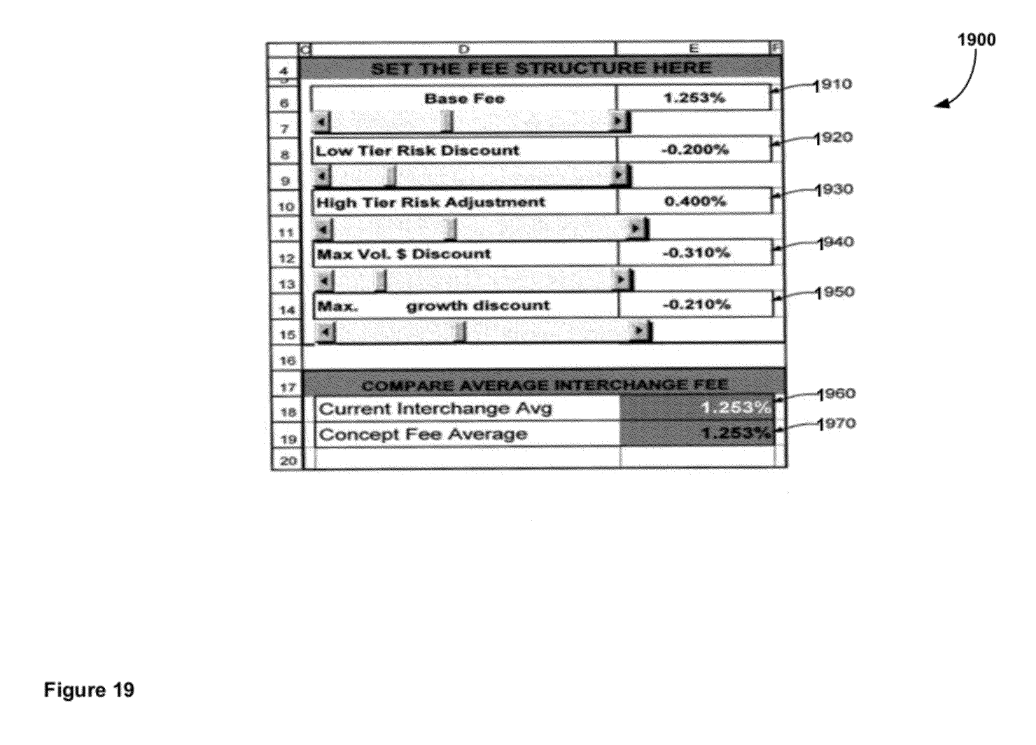

The fraud rate adjustment, shown at line 1652, displays the penalty (in the high tier column) and the discount (in the low tier column) which is applied to the merchants in the respective tiers. The fraud rate adjustments are derived from the low tier discount and the high tier adjustment specified on FIG. 19.

The chargeback section 1614 and copy request section 1616 are arranged in the same manner as the fraud rate section 1612, described above.

The volume tier section 1618 defines the volume discount tiers. The calculated volume discount for each tier and the volume distribution across each tier is shown at 1654. The growth tier section 1620 defines the growth discount tiers. The calculated growth discount for each tier and the volume distribution across each tier is shown at 1656.

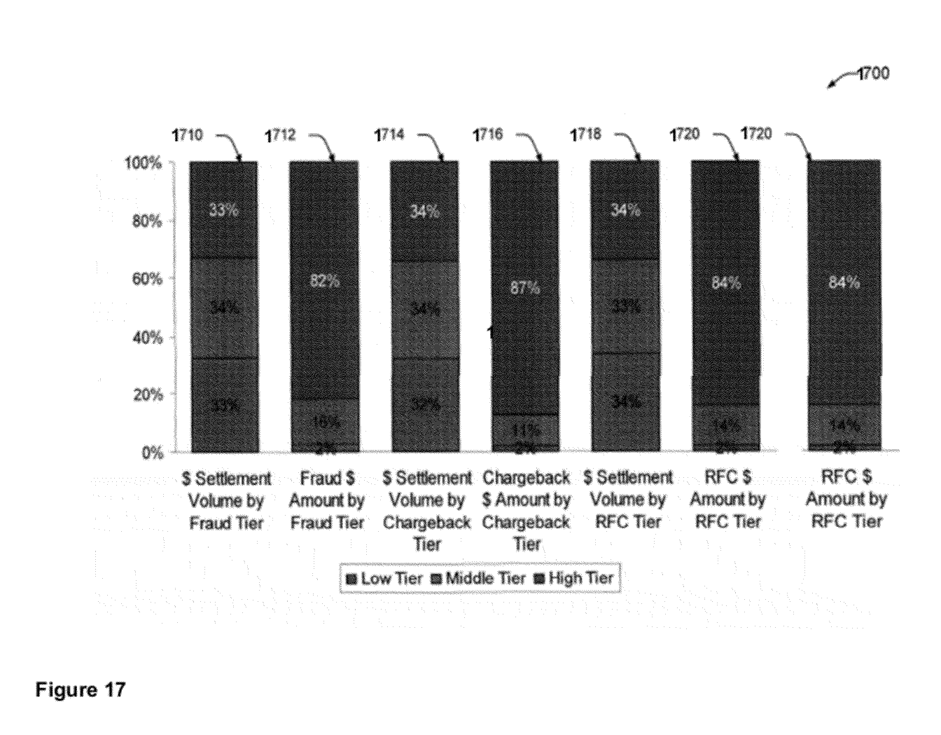

Turning to FIG. 17, an exemplary bar chart 1700 shows results of the methods in FIGS. 12-15. Bar 1712 shows the percentage of currency amount due to fraud in each tier. For example, 82% of the money attributed to fraud stems from merchants in the high fraud tier, 16% of the money attributed to fraud stems from merchants in the medium fraud tier, and 2% of the money attributed to fraud stems from merchants in the low fraud tier. In addition, the settlement currency volume across the three tiers is approximately equal at 33%, 34%, 33% as shown in bar 1710. Similar results are shown for chargeback amount (1714 and 1716) and for copy request amounts (1718 and 1720).

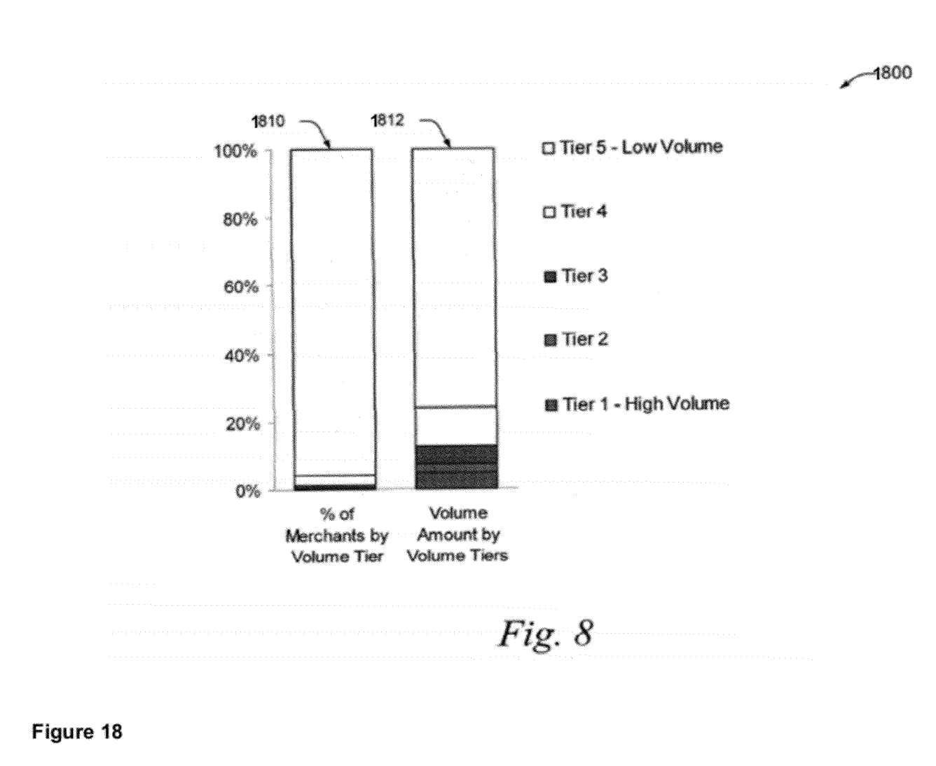

Turning to FIG. 18, an exemplary graph 1800 shows results of the methods in FIGS. 12-15. Bar 1810 shows the percentage of merchants in each volume tier. Bar 1812 shows the percentage volume currency amount in each volume tier.

Turning to FIG. 19, an exemplary user interface 1900 for specifying various performance-based model metrics is shown. The base interchange rate fee is specified at 1910. The low tier discount is specified at 1920. The high risk tier adjustment (penalty) is specified at 1930. The maximum volume discount is specified at 1940. The maximum growth discount is specified at 1950. The current interchange rate fee average determined from the raw data (before the performance-based model is applied) is shown at 1960. The conceptual interchange rate fee average after the performance-based model is shown at 1970. Even though the current and conceptual values are identical in this example, the conceptual value 1970 is determined from the performance-based model and includes the discounts and penalties to encourage changes in merchant behavior as well as volume and growth discounts. On the other hand, the current interchange average 1960 includes only volume discounts. This shows that, by balancing the discounts and penalties, merchant behavior can be incentivized while keeping the average interchange rate constant.

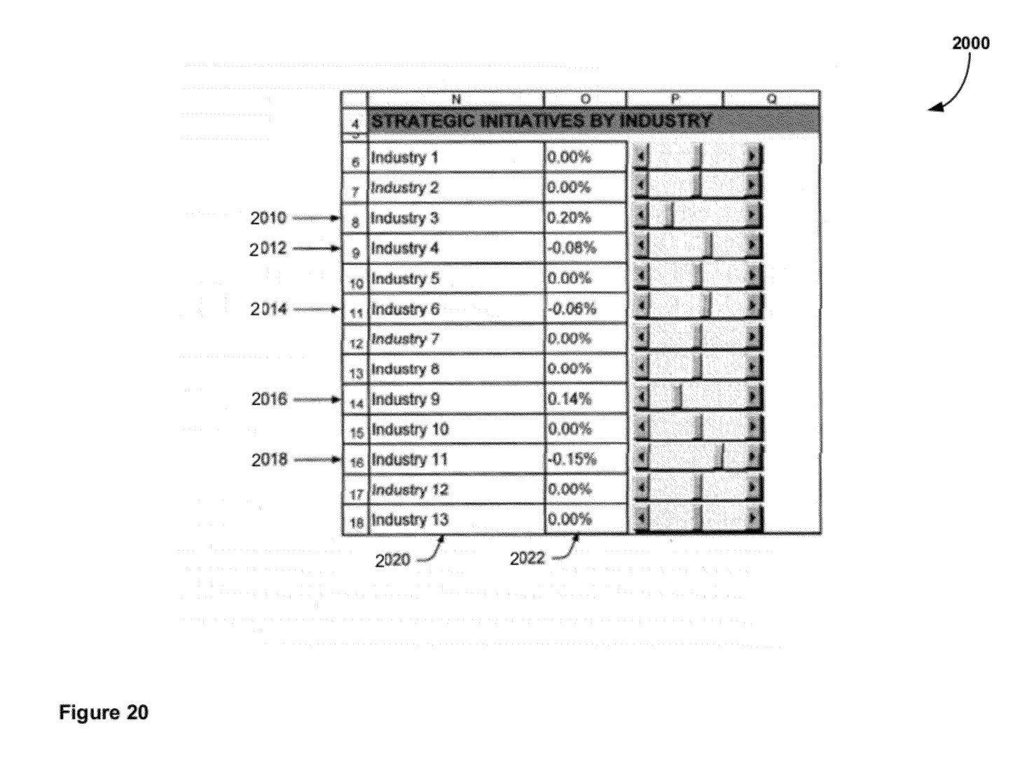

Turning to FIG. 20, an exemplary user interface 2000 for specifying various performance-based model metrics is shown. A specific interchange rate offset can be set by industry. In various implementations, the industry is air travel, auto rental, health care, food retail, utilities, telecom, petrol, and lodging. Each industry is listed in column 2020 and each industry interchange rate offset is listed in column 2022.

The offset for Industry 3, shown at 2010, is set to 0.20%. This offset is applied after the performance-based interchange rate is determined for each merchant based on the performance-based metrics, the merchant volume, and the merchant growth. The performance-based interchange rate for each merchant in Industry 3 will be offset by 0.20%.

Similarly, the offset for Industry 4 at 2012 shows a −0.08% offset. This is applied in like manner as to Industry 3. But, since this offset is negative, it is a discount. The same explanation applies to Industry 6 (2014), Industry 9 (2016), and Industry 11 (2018).

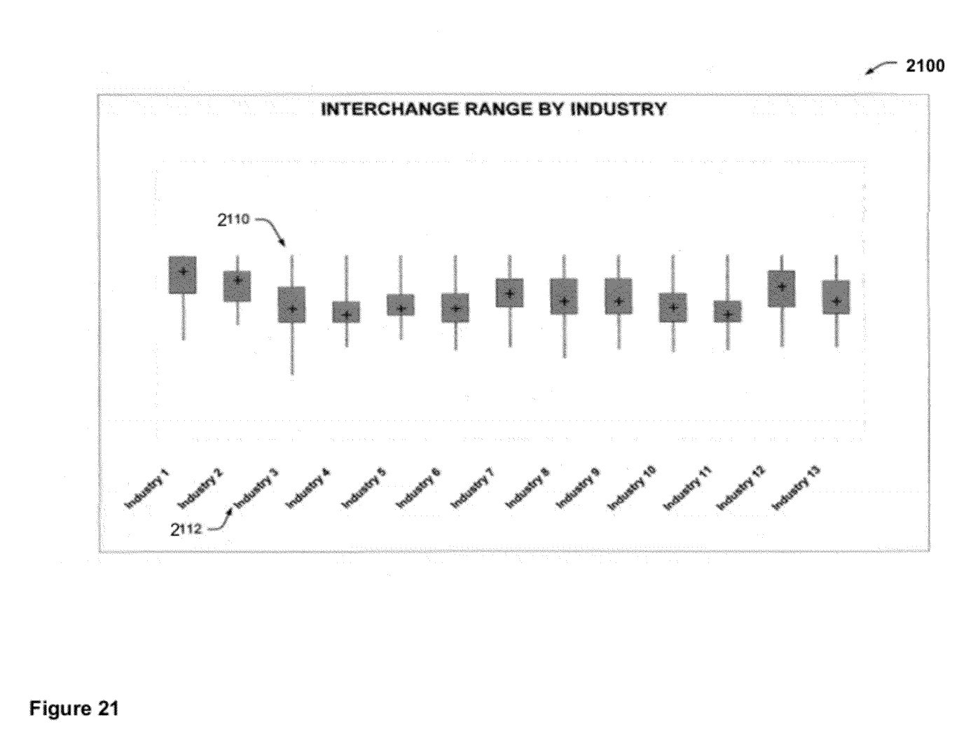

Turning to FIG. 21, an exemplary box plot 2100 shows the results of the methods in FIGS. 12-15 relating to the range of interchange rates for each industry. Each industry is identified on the x-axis 2112. For each industry, the graph identifies the minimum, maximum, 25th percentile, 75^{th} percentile, and medium for the performance-based interchange rates. For example, box 2110 relates to such statistics for Industry 3.

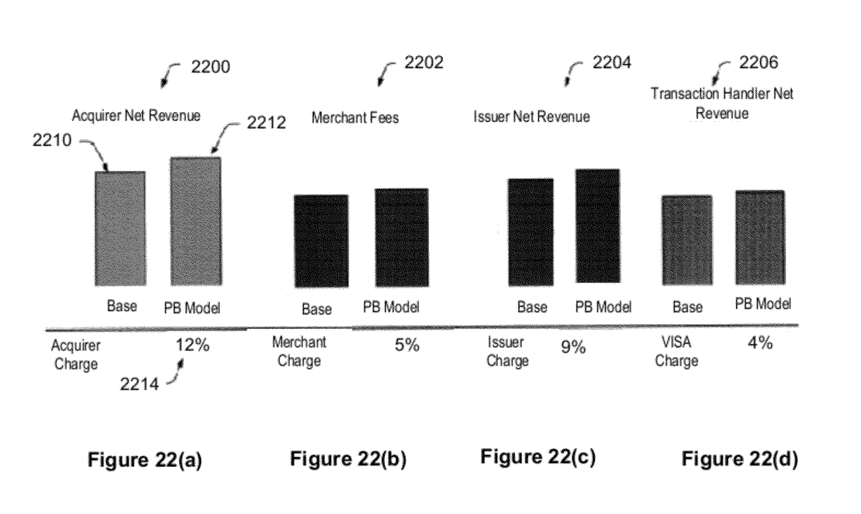

Turning to FIGS. 22(a)-22(d), bar charts 2200, 2202, 2204, and 2206 show the results of the methods in FIGS. 12-15 relating to the financial impact for different financial payment system participants as a result of the performance-based model and any strategic industry initiatives. Bar chart 2200 shows the new revenue for acquirers before (2210) and after (2212), the methods in FIGS. 12-15. The percentage change in revenue is shown at 2214. Similar bar charts are presented for merchant fees (2202), issuer revenue (2204), and transaction handler revenue (1206).

Turning to the diagram of FIG. 11, an exemplary process 1100 of a particular financial transaction system is depicted. By way of explanation for the nomenclature of reference numerals used in the Figures and described in the specification, a lower case letter in parenthesis is intended to mean an integer variable having a value from 2 to the capital case of the lower case letter, which value can be large (i.e., approaching infinity). Thus ‘(b)’ is intended to mean that the integer ‘b’ can have a value from 2 to B, and ‘(c)’ is intended to mean that the integer ‘c’ can have a value from 2 to C, etc. As such, drawing elements 1104, 1106, 1108, 1110, 1180, 1182, 1184, and 1186 in FIG. 11 are illustrated with a block, but indicate that one or more elements can be present. For example, issuer (j) 1104 is one of a possible plurality of issuers, where j may range from 2 to a large integer.

Each of the issuer (j) 1104, acquirer (i) 1106, merchant (n) 1110, and transaction handler 1102 may be a computing device (e.g., a special purpose computer) such as a server, a mainframe computer, a mobile telephone, a personal digital assistant, a personal computer, a laptop, an email enabled device, or a web enabled device having one or more processors (e.g., a Central Processing Unit, a Graphical Processing Unit, or a microprocessor) that executes an algorithm (e.g., software) to receive data, transmit data, store data, or performing methods. Each computing device may further include input/output capabilities (e.g., a keyboard, a mouse, a stylus and touch screen, or a printer), or one or more data repositories. The computing devices may include wired and wireless communication devices which can employ various communication protocols including near field (e.g., “Blue Tooth”) and far field communication capabilities (e.g., satellite communication or communication to cell sites of a cellular network) that support any number of services such as: Short Message Service (SMS) for text messaging, Multimedia Messaging Service (MMS) for transfer of photographs and videos, or electronic mail (email) access.

Account holder (p) 1108 presents an electronic payment device (i.e., a credit card) to a merchant (m) 1110 (at 1158) as tender for a financial transaction such as a purchase of goods. Other financial transactions and instruments other than credit cards may also be used, including, but not limited to, a prepaid card or a debit card. For purposes of illustration and explanation, however, reference will be generally be made to a credit card.

The payment device is read by a reader operated by the merchant (m) 1110, whereupon account information is read from the payment device and a request for authorization is transmitted to the merchant's (m) 1110 acquirer (i) 1106 (at 1166). Each acquirer (i) 1106 is a financial organization that processes credit card transactions for businesses and is licensed as a member of a transaction handler 1102 such as a credit card association (i.e., Visa Inc., MasterCard, etc.). As such, each acquirer (i) 1106 establishes a financial relationship with one or more Merchants (m) 1110.

The acquirer (i) 1106 transmits the account information to the transaction handler 1102 (at 1170), who in turn routes the request to the account holder's (p) 108 issuing bank, or issuer (j) 1104 (at 1176). The issuer (j) 1104 returns authorization information to the transaction handler 1102 (at 1174) who returns the information to the merchant (m) 1110 through the acquirer (i) 1106 (by 1168 and 1162). The merchant (m) 1110 now knowing whether the issuer's (j) 1104 credit card account is valid and supports a sufficient credit balance, may complete the transaction and the account holder (p) 1108 in turn receives goods and/or services in exchange (at 1156). Most credit card associations instruct merchants that, after receiving authorization, the detailed credit card account information obtained from the point of sale magnetic stripe scanner must be deleted.

To reconcile the financial transactions and provide for remuneration, information about the transaction is provided by the merchant (m) 1110 to acquirer (i) 1106 (at 1166), who in turn routes the transaction data to the transaction handler 1102 (at 1170) who then provides the transaction data to the appropriate issuer (j) 1104 (at 1176). The issuer (j) 1104 then provides funding for the transaction to the transaction handler 1102 (at 1174) through a settlement bank (not shown). The funds are then forwarded to the merchant's (m) 1110 acquirer (i) 1106 (at 1168) who in turn pays the merchant (m) 110 for the transaction conducted at 1162 less a merchant discount, if applicable. The issuer (j) 1104, then bills the account holder (p) 1108 (at 1150), and the account holder (p) 1108 pays the issuer 1104 (at 1152), with possible interest or fees.

An interchange fee is applied to the amount billed to the account holder (p) 1108 by the issuer (j) 1104 before the amount is deposited into the merchant's (m) 1110 acquirer (i) 1106 account (at 1170). The interchange rate is a percentage of the monetary value of the transaction. For example, consider a purchase by the account holder (p) 1108 in the amount of $100 from merchant (m) 1110 processed over a financial payments processing system, wherein the transaction is subject to a 2% interchange fee. The interchange fee of $2.00 (2% of the $100 transaction) is deducted from the amount collected from the account holder (p) 1108 and split in different proportions by the issuer, transaction handler, and acquirer. The remaining $98.00 is deposited into the merchant's (m) 1110 acquirer (i) 1106 account. As such, merchants are typically sensitive to interchange rates because, for a given price point, the higher the interchange rate, the less profit a merchant makes on a given transaction.

Each of the issuer (j) 1104, Merchant (m) 1110, acquirer (i) 1106 and the transaction handler 1102 may have access to information resources having one or more of the following data repositories: transactions database (z) 1182, merchants database (y) 1184, accounts database (w) 1180, and/or other database (v) 1186. These data repositories can be connected by a network, internet, virtual private network, or by other means. Moreover, not every participant must necessarily have access to any or all of the data repositories. Each data repository can assign read, write, and query permissions as appropriate to the various participants. For example, a merchant (m) no has only read access to the accounts database (w) 1180 whereas the issuer (j) 1104 may have read and write access. The data repositories 1182, 1184, 1180, and 1186 may include one or more hard disk drives, tape cartridge libraries, optical disks, or any suitable volatile or nonvolatile storage medium, storing any combination of databases, or the components thereof, in a single location or in multiple locations, or as an array such as a Direct Access Storage Device (DASD), redundant array of independent disks (RAID), virtualization device, . . . etc. The data repository may be structured by a database model, such as a relational model or a hierarchical model.

The transactions database (z) 1182 is designed to store some or all of the transaction data originating at the Merchant (m) 1110 involving a payment device. The transaction data may include information associated with the account of an account holder (p) 1108, date, time, and location among other more specific information including the amount of the transaction. The database can be searched using account information, date and time (or within proximity thereof), or by any other field stored in the database.

The merchants database (y) 1184 is designed to store information about each merchant (m) 1110. The merchants database (y) 1184 can contain information such as the unique identification of each merchant (m) 1110, an identifier for each point of sale device in use by the merchant (m) 1110, and location of the merchant (m) 1110.

The accounts database (w) 1180 is designed to store account information for payment devices associated with account holder (P). The accounts database (w) 1180 can store part or all of an account number, a unique encryption key, account name, and other account information. The information from the accounts database (w) 1180 can be associated with information from the transactions database (z) 1182.

An account holder (p) 1108 initiates a transaction with a merchant (m) 1110 by presenting a payment device at 1158 to the merchant (m) 1110. The payment device is typically presented at the Point Of Service terminal (POS) at which data thereon is read. Certain transaction information is transmitted from the POS in route to the merchant's (m) 1110 acquirer (i) 1106. The transaction information can include account information, account name, transaction balance, transaction time, transaction date, and transaction location. Sensitive information includes information such as account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the merchant (m) 1110, and the ultimate destination, such as the acquirer (i) 1106. These points can include, without limitation, from the reader at the POS, the POS at the merchant (m) 1110 and a network router or computer that is connected to a network but is housed and maintained by the merchant (m) 1110 and between the merchant (m) 1110 and the acquirer (i) 1106. The communication channel could be Ethernet, wireless internet, satellite, infrared transmission, or other known communication protocols. Some or all of the transmission may also be stored for record keeping, archival or data mining purposes with little or no encryption. For example, the merchant (m) 1110 may store transaction data, including certain account information in the merchant's (m) 1110 accounts on file database for reuse later.

In this process, transaction information is retrieved from the POS at a merchant (m) 1106. The transaction information is comprised of account information together with other information about the transaction itself: time, date, location, value, etc. Certain of the transaction information is considered sensitive information including, without limitation, account number, credit card verification number, and account name.

FIG. 11 illustrates a telecommunications network that may make use of any suitable telecommunications network and may involve different hardware, different software and/or different protocols then those discussed below. FIG. 11 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared, and settled as either a dual message or a single message transaction. A dual message transaction is sent twice the first time with only information needed for an authorization decision, and again later with additional information for clearing and settlement. A single message transaction is sent once for authorization and contains clearing and settlement information as well. Typically, authorization, clearing and settlement all occur on-line.

FIG. 11 includes one or more transaction handlers 1102, access points 1130, 1132, acquirers (i) 1106, and issuers (j) 1104. Other entities such as drawee banks and third party authorizing agents may also connect to the network through an access point. An interchange center is a data processing center that may be located anywhere in the world. In one implementation, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handler 1102) to remote entities use dedicated high band width telephone circuits or satellite connections based on the IBM SNA-LUO communication protocol. Messages are sent over these lines using any suitable implementation of the ISO 8583 standard.

Access points 1130 and 1132 are typically made up of small computer systems located at a processing center that interfaces between the center's host computer and the interchange center. The access point facilitates the transmission of messages and files between the host and the interchange center supporting the authorization, clearing and settlement of transaction. Telecommunication links between the acquirer (i) 1106 and its access point 1132 and between the access points 1130 and issuer (i) 1104 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

In order to address various issues and improve over previous works, the application is directed to TRANSACTION RATE PROCESSING APPARATUSES, METHODS AND SYSTEMS. The entirety of this application (including the Cover Page, Title, Headings, Field, Background, Summary, Brief Description of the Drawings, Detailed Description, Claims, Abstract, Figures, Appendices, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a TRP individual and/or enterprise user, database configuration and/or relational model, data type, data transmission and/or network framework, syntax structure, and/or the like, various embodiments of the TRP, may be implemented that provide a great deal of flexibility and customization. For example, aspects of the TRP may be adapted for generating and assigning transaction rate values to payment instruments (e.g., credit cards, debit cards, lines of credit, etc.) associated with user or consumers based their individual transaction history. Other aspects of the TRP may be adapted for generating and assigning transaction rate values to any payment instruments (e.g., interest rates of credit cards, debit cards, lines of credit, etc.) or transaction charges (e.g., interchange rates, etc.) associated with the transaction histories of either individual or groups of consumers, corporations (e.g., corporate credit cards), or merchants. While various embodiments and discussions of the TRP have been directed to generating transaction rates, however, it is to be understood that the embodiments described herein may be readily configured and/or customized for a wide variety of other applications and/or implementations.

What is claimed is:

1. A merchant transaction rate processor-implemented method, comprising:
accessing at least one transaction-based performance metric associated with a merchant;
assigning a transaction adjustment value to the transaction-based performance metric;
assigning a plurality of risk-level tiers to the assigned transaction adjustment value in order to form a plurality of adjustment value risk-level regions;
distributing the assigned transaction adjustment value among the plurality of adjustment value risk-level regions, wherein each of the plurality of adjustment value risk-level regions includes an assigned risk-level transaction adjustment value;
determining a rate of occurrence for the at least one transaction-based performance metric;
determining one of the plurality of adjustment value risk-level regions that corresponds to the determined rate of occurrence; and
assigning a corresponding assigned risk-level transaction adjustment value to the determined one of the plurality of adjustment value risk-level regions.

2. The method of claim 1, wherein the at least one transaction-based performance metric comprises at least one of a fraud rate, a charge-back rate, and a copy request rate.

3. The method of claim 1, wherein the at least one transaction-based performance metric comprises transaction declined rates.

4. The method of claim 1, wherein the at least one transaction-based performance metric comprises growth rates.

5. The method of claim 1, wherein the at least one transaction-based performance metric comprises sales volume.

6. The method of claim 1, wherein the at least one transaction-based performance metric comprises merchant industry category.

7. The method of claim 1, wherein the at least one transaction-based performance metric comprises merchant product type sales volume.

8. The method of claim 1, wherein the corresponding assigned risk-level transaction adjustment value comprises a positive percentage indicative of an increased risk associated with the at least one transaction-based performance metric.

9. The method of claim 1, wherein the corresponding assigned risk-level transaction adjustment value comprises a negative percentage indicative of a decrease in risk associated with the at least one transaction-based performance metric.

10. The method of claim 1, wherein the plurality of adjustment value risk-level regions comprises a low risk tier, a medium risk tier, and a high risk tier.

11. The method of claim 1, further comprising:
providing a base transaction rate; and
aggregating the base transaction rate with the corresponding assigned risk-level transaction adjustment value to generate a net merchant transaction rate.

12. The method of claim 1, wherein:
the base transaction rate comprises a base interchange rate;
the corresponding assigned risk-level transaction adjustment value comprises an assigned risk-level interchange adjustment value; and
the net merchant transaction rate comprises a merchant interchange rate.

13. The method of claim 1, further comprising:
receiving a previous assigned risk-level transaction adjustment value corresponding to the at least one transaction-based performance metric;
comparing the previous assigned risk-level transaction adjustment value with the corresponding assigned risk-level transaction adjustment value;
sending, to the merchant, a first transaction performance target information when, based on the comparing, the corresponding assigned risk-level transaction adjustment value is greater than the previous assigned risk-level transaction adjustment value; and
sending, to the merchant, a second transaction performance target information when, based on the comparing, the corresponding assigned risk-level transaction adjustment value is less than the previous assigned risk-level transaction adjustment value.

14. The method of claim 13, wherein the first transaction performance target information comprises presenting the merchant with an incentive to reduce the corresponding assigned risk-level transaction adjustment value by a set amount by reducing the rate of occurrence for the at least one transaction-based performance metric by a predetermined amount.

15. The method of claim 13, wherein the second transaction performance target information comprises presenting the merchant with an alert that the corresponding assigned risk-level transaction adjustment value will increase by a set amount based on an increase in the rate of occurrence for the at least one transaction-based performance metric by a predetermined amount.

16. A merchant transaction rate processor-implemented method, comprising:
providing merchant transaction security information;
determining a merchant transaction equipment type from the merchant transaction security information;
assigning a risk-level transaction adjustment value to the determined merchant transaction equipment type; and
generating a merchant transaction rate by adding the assigned risk-level transaction adjustment value to a base transaction rate.

17. The method of claim 16, wherein:
the risk-level transaction adjustment value comprises a risk-level interchange adjustment value; and
the merchant transaction rate comprises a merchant interchange rate.

18. The method of claim 16, wherein the merchant transaction equipment type comprises a model number associated with a point of presence (POS) terminal, the model number indicative of anti-fraud security measures incorporated by the point of presence (POS) terminal.

19. The method of claim 18, wherein the anti-fraud security measures comprise at least one security question presented to a user when processing the user's payment instrument at the point of presence (POS) terminal.

20. The method of claim 18, wherein the anti-fraud security measures comprise electronic wallet transaction capabilities.

21. The method of claim 18, wherein the anti-fraud security measures comprise biometric identification.

22. The method of claim 18, wherein the risk-level transaction adjustment value comprises a negative value for discounting the merchant transaction rate.

23. The method of claim 18, wherein the risk-level transaction adjustment value comprises a positive value for increasing the merchant transaction rate.

24. A merchant transaction rate system, comprising:
a memory; and
a processor disposed in communication with the memory and configured to issue processing instructions stored in the memory to:
access at least one transaction-based performance metric associated with a merchant;
assign a transaction adjustment value to the transaction-based performance metric;
assign a plurality of risk-level tiers to the assigned transaction adjustment value in order to form a plurality of adjustment value risk-level regions;
distribute the assigned transaction adjustment value among the plurality of adjustment value risk-level regions, wherein each of the plurality of adjustment value risk-level regions includes an assigned risk-level transaction adjustment value;
determine a rate of occurrence for the at least one transaction-based performance metric;
determine one of the plurality of adjustment value risk-level regions that corresponds to the determined rate of occurrence; and
assign a corresponding assigned risk-level transaction adjustment value to the determined one of the plurality of adjustment value risk-level regions.

25. A processor-readable tangible medium storing processor-issuable merchant transaction rate instructions to:
access at least one transaction-based performance metric associated with a merchant;
assign a transaction adjustment value to the transaction-based performance metric;
assign a plurality of risk-level tiers to the assigned transaction adjustment value in order to form a plurality of adjustment value risk-level regions;
distribute the assigned transaction adjustment value among the plurality of adjustment value risk-level regions, wherein each of the plurality of adjustment value risk-level regions includes an assigned risk-level transaction adjustment value;
determine a rate of occurrence for the at least one transaction-based performance metric;
determine one of the plurality of adjustment value risk-level regions that corresponds to the determined rate of occurrence; and
assign a corresponding assigned risk-level transaction adjustment value to the determined one of the plurality of adjustment value risk-level regions.

26. A merchant transaction rate system, comprising:
a memory; and
a processor disposed in communication with the memory and configured to issue processing instructions stored in the memory to:
provide merchant transaction security information;
determine a merchant transaction equipment type from the merchant transaction security information;
assign a risk-level transaction adjustment value to the determined merchant transaction equipment type; and
generate a merchant transaction rate by adding the assigned risk-level transaction adjustment value to a base transaction rate.

27. A processor-readable tangible medium storing processor-issuable merchant transaction rate instructions to:
provide merchant transaction security information;
determine a merchant transaction equipment type from the merchant transaction security information;
assign a risk-level transaction adjustment value to the determined merchant transaction equipment type; and
generate a merchant transaction rate by adding the assigned risk-level transaction adjustment value to a base transaction rate.

28. A method comprising a plurality of steps each being performed by computing apparatus executing software, wherein the steps include:
for a plurality of merchants, calculating for each of said merchants:
an occurrence rate for a plurality of performance metrics, and
a settlement currency volume;
for each said performance metric:
calculating a high zone, a medium zone, and a low zone;
assigning a high zone interchange rate adjustment for the said performance metric to the high zone of the performance metric;
assigning a medium zone interchange rate adjustment for the said performance metric to the low zone of the performance metric;
assigning a zero interchange rate adjustment to the medium zone;
associating each said merchant with one of the high zone, the medium zone, and the low zone according to the magnitude of each said merchant's occurrence rate for each performance metric of a plurality of said performance metrics, wherein a combined settlement currency volume for said merchants in each of the high zone, the medium zone, and the low zone are approximately equal;
for each said merchant, calculating a merchant-specific interchange rate by:
assigning the base interchange rate to an intermediate interchange rate; for each said performance metric and for each of the high zone, medium zone, and low zone:
adding to the intermediate interchange rate:
the high zone interchange rate adjustment if the merchant was associated with the high zone;
the low zone interchange rate adjustment if the merchant was associated with the low zone; and
the medium zone interchange rate adjustment if the merchant was associated with the high zone;
adding a volume discount adjustment based on a total settlement currency volume for all merchants to the intermediate interchange rate;
adding a growth discount offset based on a total settlement currency growth rate for the merchant to the intermediate interchange rate;
assigning the intermediate interchange rate to the merchant-specific interchange rate; and publishing the merchant-specific interchange rate.
